(19) United States
(12) Patent Application Publication
(10) Pub. No.: US 2010/0166165 A1
(43) Pub. Date: Jul. 1, 2010

(54) SYSTEM AND METHOD FOR REAL-TIME, PERSONALIZED, DYNAMIC, INTERACTIVE VOICE SERVICES FOR ENTERTAINMENT-RELATED INFORMATION

(75) Inventors: Justin Langseth, Reston, VA (US); Nicolas J. Orolin, McLean, VA (US); Anurag Patnaik, Arlington, VA (US); Michael Zirngibl, Washington, DC (US); Michael J. Saylor, Vienna, VA (US); Frederick Richards, III, Washington, DC (US)

Correspondence Address: PILLSBURY WINTHROP SHAW PITTMAN, LLP, P.O. BOX 10500, MCLEAN, VA, 22102, US

(73) Assignee: MicroStrategy, Incorporated, McLean, VA (US)

(21) Appl. No.: 12/722,236

(22) Filed: Mar. 11, 2010

Related U.S. Application Data
(63) Continuation of application No. 11/089,035, filed on Mar. 25, 2005, now abandoned.

(51) Int. Cl. G06F 15/16; G10L 13/08; H04M 3/42

(52) U.S. Cl. 379/201.01; 704/260; 709/227; 704/E13.001

(57) ABSTRACT

A system and method for creation and automatic deployment of personalized, dynamic and interactive voice services relating to subscriber entertainment, including information derived from on-line analytical processing (OLAP) systems. More specifically, the invention relates to a system and method that enable personalized delivery of entertainment-related information in real-time, via natural language voice communication with a voice-enabled terminal device.

### FIELD OF THE INVENTION

This invention relates to a system and method for creation and automatic deployment of personalized, dynamic and interactive voice services relating to subscriber arts and entertainment, including information derived from on-line analytical processing (OLAP) systems. More specifically, the invention relates to a system and method that enable personalized delivery of entertainment-related information in real-time, via natural language voice communication with a voice-enabled terminal device.

### BACKGROUND OF THE INVENTION

Various systems exist for enabling users to initiate a request for information about various arts and entertainment opportunities. Some of these services, for example, allow a user to purchase tickets to entertainment events. These systems are typically telephone or Internet-based systems that simply list available options and allow the user to purchase tickets. This poses a problem for many people because a person interested in a particular performer or type of performance may not have heard about an event until well after tickets became available. As a results the person may not be able to get tickets or may get tickets in an undesirable location in the arena or auditorium where the event takes place.

These and other drawbacks exist with existing entertainment systems.

### SUMMARY OF THE INVENTION

An object of the invention is to overcome these and other drawbacks in existing systems and methods.

Another object of the invention is to provide real-time, dynamic, interactive voice services relating to entertainment opportunities. An entertainment opportunity includes, for example, events, products and services, both free and for sale, designed to divert or amuse. Based upon the occurrence of a predetermined event, such as passage of a predetermined amount of time or receipt of new entertainment information, a telecast may be executed. During the telecast, a user is given the opportunity to provide input, and receive additional information based upon the input. The input may also provide the user with the opportunity to reserve or purchase an entertainment opportunity.

Another object of the invention is to enable real-time, dynamic, interactive voice services relating to entertainment for particular subscribers to a service based upon a personal profile and a user history. A user creates a personal profile. A data warehouse stores user data and creates a user history. The personal profile and the user history may determine the information from the voice services that is delivered to a particular user.

Another object of the invention is to provide real-time, dynamic, interactive voice services relating to changes in entertainment opportunities of interest. These entertainment opportunities may be either purchased on non-purchased opportunities. Purchased opportunity updates may be limited, for example, to cancellations, delays, or reschedulings. Non-purchased opportunity updates may, for example, include updates relating to the price of the opportunity, the availability of the opportunity, as well as information on cancellations, delays, or reschedulings.

Another object of the present invention is to automatically register a user for at least one additional voice service based upon input received during the execution of an entertainment service. For instance, if a user purchases a sporting event ticket, the user may be registered for additional entertainment services automatically relating to that event. Automatic registrations may be determined by the user's input to a particular question, such as an affirmative response to a question asking if more information about related entertainment opportunities is desired. Additionally, the automatic registration may be determined by user settings or any other criteria established by the entertainment service provider.

These and other objects of the invention are accomplished according to various embodiments of the invention. According to one embodiment of the invention, a user is provided with entertainment opportunity information through one or more entertainment services. Entertainment services, as used herein, should be understood to be real-time, interactive, dynamic voice services generated upon the occurrence of a predetermined condition. A user subscribes to one or more entertainment services.

The entertainment services are dynamic in that the information provided to each user depends at least partially upon the entertainment service and partially upon information associated with the user, such as a personal profile and user history. For example, a service delivered to two different users, John and Susan, would address each of them by their respective names.

The entertainment services are interactive in that the information provided to the user depends at least partially upon the input received by the user. For example, if a user has subscribed to a nightly entertainment service, the user may be presented with inputs, including, options relating to a number of different nightly entertainment categories, such as television shows, movies, and plays. After the user selects input relating to television shows, the telecast would then provide more detailed information relating specifically to the nightly television shows.

According to another embodiment, the information may be limited based on the personal profile or user history before it is provided to a subscriber, or user subscribed to a particular service. For example, a personal profile and a user history may determine whether information within the entertainment service is delivered to a particular user.

A personal profile may establish filters that prevent types of information from being delivered. Alternatively, a personal profile may ensure that information within a subscribed service is delivered. Additionally, parameters may be weighted so that a user may or may not receive information regarding a particular entertainment opportunity. For example, a subscriber to a concert service may elect to receive all information about Performer 1, no information about Performer 2, and information about Performer 3 if there are no other qualified entertainment opportunities.

A user history may also be created and stored and may establish filters that determine the types of information that are to be delivered. Also, a user history may ensure that information within a subscribed service is delivered. Additionally, the purchase history may be a factor in determining whether a user receives information relating to a particular entertainment opportunity. For instance, a subscriber to a video service may not be informed of the availability of Video 1 if the user rented Video 1 last week.

According to another embodiment of the present invention, a user is informed of changes in entertainment opportunities. A subscriber to a service may not receive subsequent notifications of the same entertainment opportunities. However, if the entertainment opportunity changes, a user may be notified. For example, if a user purchases tickets to a sporting event, the user may not wish to hear continued information relating to the purchase of that event's tickets. Accordingly, information within an entertainment service relating to the event may not continue to be delivered to users who have purchased the event's tickets. If there is a change relating to the event, such as a cancellation, purchasers of the event's tickets may be informed automatically of such changes.

Another embodiment of the invention relates to a system and method for creation and automatic deployment of personalized, dynamic and interactive voice services, including information derived from on-line analytical processing (OLAP) systems and other data repositories. The system and method enables the ability to capture user selections to facilitate closed-loop transaction processing and processing of other requests. One aspect of the invention relates to an interactive voice broadcasting system and method that enables analytical reporting and advanced transactional services via the telephone or other voice-enabled terminal device. One advantage of the invention is that a voice service may leverage the power of OLAP or other data repository systems and provide critical information to the user, in a timely fashion, by phone. Another advantage of this method and system is that it provides a user with the opportunity to immediately act upon information received during a interactive voice broadcast.

A voice service is created and can have many users subscribed to the voice service. Each user can specify personal preferences for the content and presentation of the contents for a voice service. The specification of the elements of a voice service may be done using a set of interfaces (such as GUIs) that take the form of a voice service wizard.

A voice service includes one or more Dialog elements. Dialog elements may include one or more of Speech elements, Input elements and Error elements. An Input element may include a Prompt element and/or an Option element. An Input element enables the system to request input from the user, capture the input and direct the call flow based on the user's input. An Option element associates a key (e.g., on a telephone touch pad dial) with a destination Dialog that is executed when that number is pressed by a user during an interactive voice broadcast. A Prompt requests a user to enter numeric or other information. An Input element may enable a user to request, during an interactive voice broadcast, a transaction, a service or other requests. The term transactions, services and requests are to be interpreted broadly.

According to one embodiment, the user's responses to Input elements are stored during an interactive voice broadcast and, during or after the voice broadcast, the stored information is processed by the system or is passed to another system or application for processing. The transaction (or other request) processing can be accomplished either in real-time, during the voice broadcast, or after the interactive voice broadcast is completed. The results or confirmation of a transaction or other request can be provided to the user during the call or subsequently.

Once a voice service is created, the system monitors predetermined conditions to determine when the voice service should be executed. Each voice service is executed when one or more predetermined conditions are met as specified during creation of the voice service. For example, a voice service may be executed according to a predetermined schedule (time-based) or based on a triggering event (e.g. one or more conditions are met based on the output of an OLAP or other report).

When the predetermined condition is satisfied, the voice service is executed. Executing a voice service, includes the steps of generating the content specified by the voice service and the user preferences. Some users may have identical personalization options and, thus, a single call structure may be generated for a group of users with identical personalization options. The content of the voice service includes the information that is to delivered to users of that voice service, and the Input to be requested from the user, among other things. The content may include, for example, static text messages, dynamic content (e.g. text based on information output from an OLAP report, other database or other sources) or blended text (e.g. static text combined with dynamic content).

This and other content are formatted in an Active Voice Page (AVP). An AVP contains the call structure and data. The AVP contains data at various hierarchical levels that are defined by the Dialog elements defined for each voice service. The active voice pages are used to help govern the interaction between the call server and the user during an IVB. According to one embodiment, the content is formatted, into an AVP e.g., using XSL stylesheets so the AVP is in an XML-based language. According to one embodiment, the XML-based language used is a novel language referred to as TML (discussed below). The AVP is sent to a call server along with style properties for each user. The style properties of a user help determine the behavior of the call server during an interactive voice broadcast. A unique AVP is generated for each user scheduled to receive a voice service.

When a user is called by the call server, information is passed through a T-T-S engine and delivered to the user through a voice-enabled terminal device. Preferably, the structure of each call is dynamic, driven by current data values and is personalized based on a user profile established during subscription to a voice service. During a typical interactive voice broadcast, a synthesized, natural sounding voice greets the recipient by name, identifies itself, provides information relevant to the user and enables a user to provide input back to the system.

An IVB is a voice-enabled interaction with a user having, a dynamic structure controlled by the AVP for the particular user. The IVB may be delivered using real-time, on-the-fly speech generation. During an IVB, information is exchanged between the call server and a user according to the AVP. The system executes dialogs by reading messages to the user and, eliciting input from the user. For example, the user may press buttons on a telephone touch pad dial to select an option or to provide numeric or alphanumeric input. Each response provided by a user may transfer control of the IVB to a different part of the AVP.

During or after the IVB, the user's responses may be processed by the system or other applications. The AVP may contain pointers to other applications and embedded statements such that when a user exercises an option, the system performs a requested operation and returns the results to the user during the IVB. For example, by exercising an option, a user may request that a real-time database query be performed. When the user selects such an option, control is shifted to a portion of the AVP that contains an embedded SQL statement that is made against a database.

When a user has worked through selected dialogs of the AVP, the IVB is terminated. That is, a user likely will not work through all of the available dialogs during an IVB. Rather, the user's inputs and option selections determine which the available dialogs are encountered during any given IVB.

### BRIEF DESCRIPTION OF THE DRAWINGS

FIG. 1a is a flow chart of a method in accordance with an embodiment of the present invention.

FIG. 1b is a flow chart indicating a method of generating a voice service according to one embodiment of the present invention.

FIG. 1c is a flow chart indicating a method for interactive voice broadcasting according to an embodiment of the present invention.

FIG. 2 is a flow chart indicating a sequence of an interactive voice broadcast according to one embodiment of the present invention.

FIG. 3a is a schematic block diagram of a system in accordance with an embodiment of the present invention.

FIG. 3b is a schematic block diagram of an intelligence server according to an embodiment of the present invention.

FIG. 3c is a schematic block diagram of call server according to an embodiment of the present invention.

FIG. 4 is a schematic block diagram of a commercial transaction processing system according to an embodiment of the present invention.

FIG. 5 is a flow chart of a method of using a voice service bureau according to an embodiment of the present invention.

FIG. 6a is a schematic block diagram of a voice service system incorporating a voice service bureau according to one embodiment of the present invention.

FIG. 6b is block diagram of a primary voice bureau according to one embodiment of the present invention.

FIG. 6c is a block diagram of a backup voice bureau according to another embodiment of the present invention.

FIG. 7 is a flow chart illustrating a method for integrating inbound and outbound voice services.

FIG. 8 is a block diagram of a call server configured to provide integrated inbound and outbound voice services.

FIG. 9 is a flow chart of a method in accordance with an embodiment of the invention relating to entertainment services.

FIG. 10 is a flow chart of a method in accordance with an embodiment of the invention relating to entertainment services from the user perspective.

FIGS. 11(a) to 11(d) illustrate a possible set of Graphical User Interfaces (GUIs) in accordance with an embodiment of the invention.

FIG. 12 is an exemplary flow chart of a user interaction with a particular entertainment service according to an embodiment of the invention.

FIG. 13 is a flow chart of a method in accordance with an embodiment of the invention relating to changed information about entertainment opportunities.

FIG. 14 is a flow chart of a method in accordance with an embodiment of the invention relating to subscription to a new service based upon user input.

### DETAILED DESCRIPTION

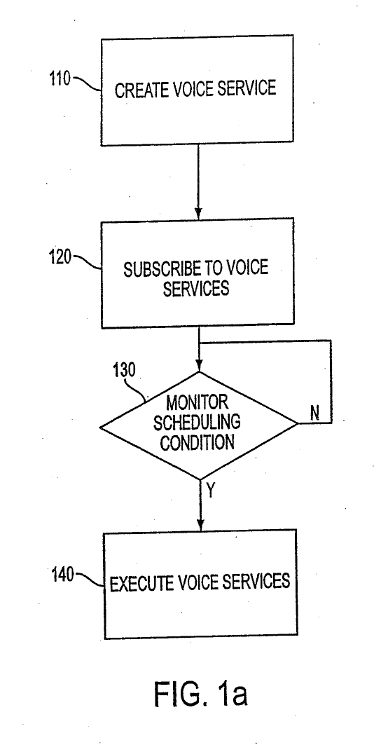

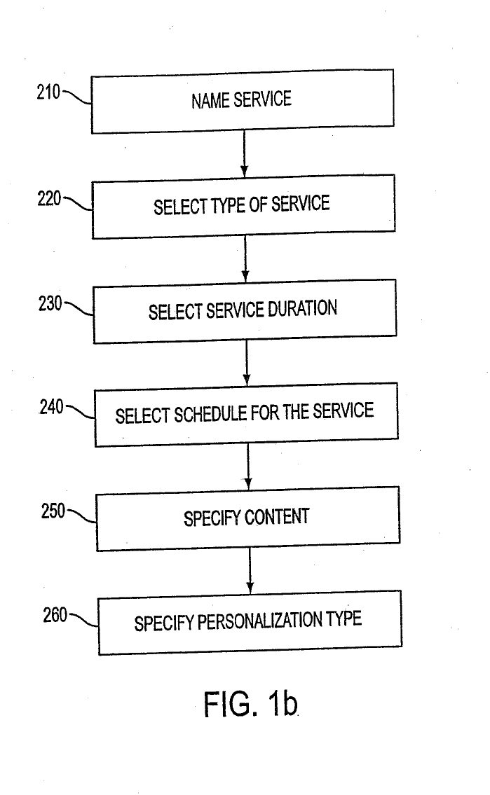

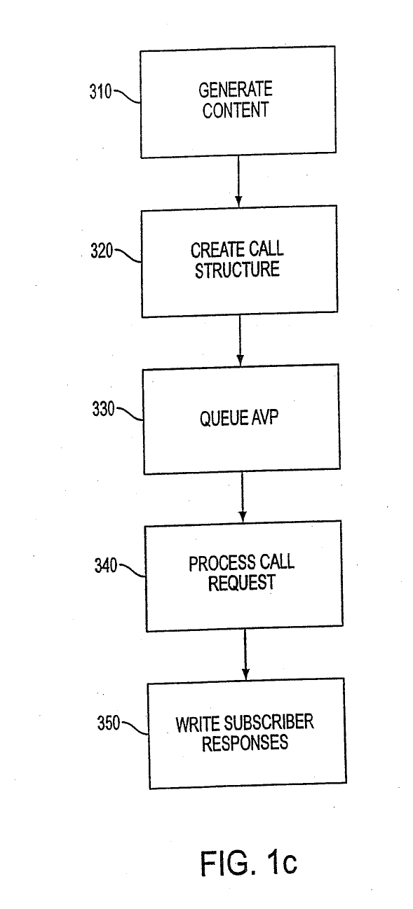

FIGS. 1-8 describe an overall system and method as described below that may be used to generate voice communication and receive user input for use with the present invention. More particularly, however, the present invention relates to the output of entertainment related information based on the entertainment services to which a user is subscribed, a personal profile, and a user history.

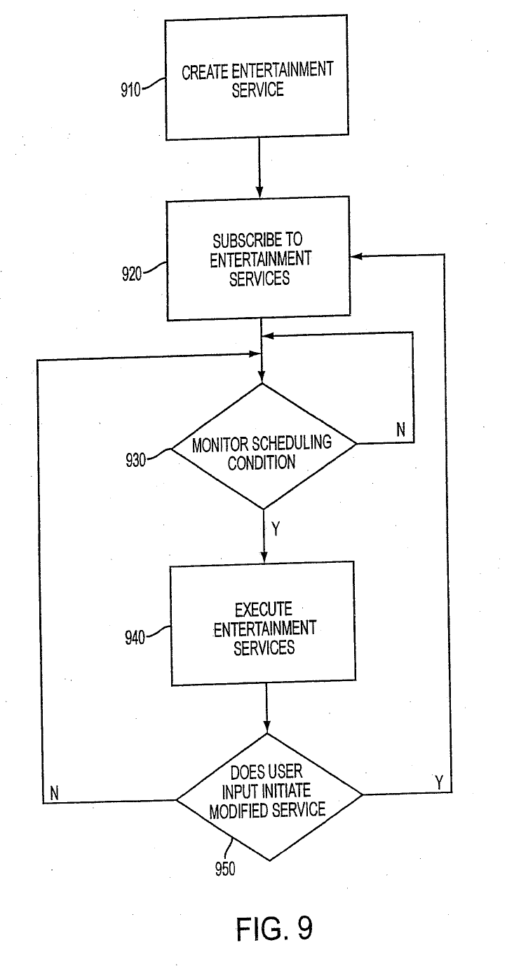

According to one embodiment of the invention, a system is provided for automatic, interactive, real-time, voice transmission of information relating to entertainment opportunities to one or more users. FIG. 9 illustrates a flow chart of a method according to an embodiment of the invention. At step 910, an entertainment service may be created. At step 920, a user may subscribe to an entertainment service. A data source may be monitored at step 930 to determine whether the scheduling condition has been satisfied. Once the scheduling condition has been satisfied, the entertainment service may be executed at step 940. At step 950, a preferred embodiment includes a determination of whether the user should be subscribed to a new service based upon the user input. Each of these steps is explained in more detail below.

According to a preferred embodiment, an entertainment service is created at step 910. This entertainment service may be created by an affiliate of the entertainment provider, a third party aggregator of entertainment information, the user, or other party. In a preferred embodiment, entertainment services represent categories of information relating to services. For example, a service creator may develop a concert entertainment service, a weekend entertainment service, or other service. The level of detail for these services is determined by the service creator. For example, in addition to having the concert and weekend entertainment services, a service creator may also create a weekend concert service. Any organization of information that provides users with ready access to meaningful entertainment information would be an appropriate entertainment service.

At step 920, a user preferably subscribes to an entertainment service. In a preferred embodiment, subscription is completely dependent upon affirmative selections made by the user. For example, a user may not be subscribed to a service unless the user makes an affirmative selection to subscribe. Alternatively, an entertainment service creator or a third party may subscribe users to a particular entertainment service. Preferably, each entertainment service provides the user with the ability to unsubsbcribe to a particular entertainment service as well.

At step 930, the scheduling condition is monitored. Until the scheduling condition is satisfied, the system does not proceed to step 940. Step 930 may include monitoring based upon the announcement of an entertainment opportunity, the passage of a predetermined amount of time, a combination of the two, or other criteria.

Depending upon the entertainment service, the processing capacity of the hardware and software utilized in the system, and other criteria, a service creator may establish how often the monitoring takes place for a particular entertainment service. For example, a service creator establish a service that monitors the satisfaction of the trigger event every minute for a time-sensitive service, information about tickets for sale for the Super Bowl. Additionally, the user may also be allowed to provide input regarding how often the monitoring takes place. In this embodiment, a user requesting more frequent monitoring may be charged a higher service price than a user requesting less frequent monitoring.

Upon satisfaction of the scheduling condition, the system may proceed to step 940. In step 940, the system executes the entertainment service. For example, using the previous example in which availability of Super Bowl tickets was the trigger, the system would execute the Super Bowl service once it acquired information relating to ticket availability. Users subscribed to the Super Bowl service would preferably receive the interactive telephone call relating to the ticket availability in accordance with the invention as described in more detail below.

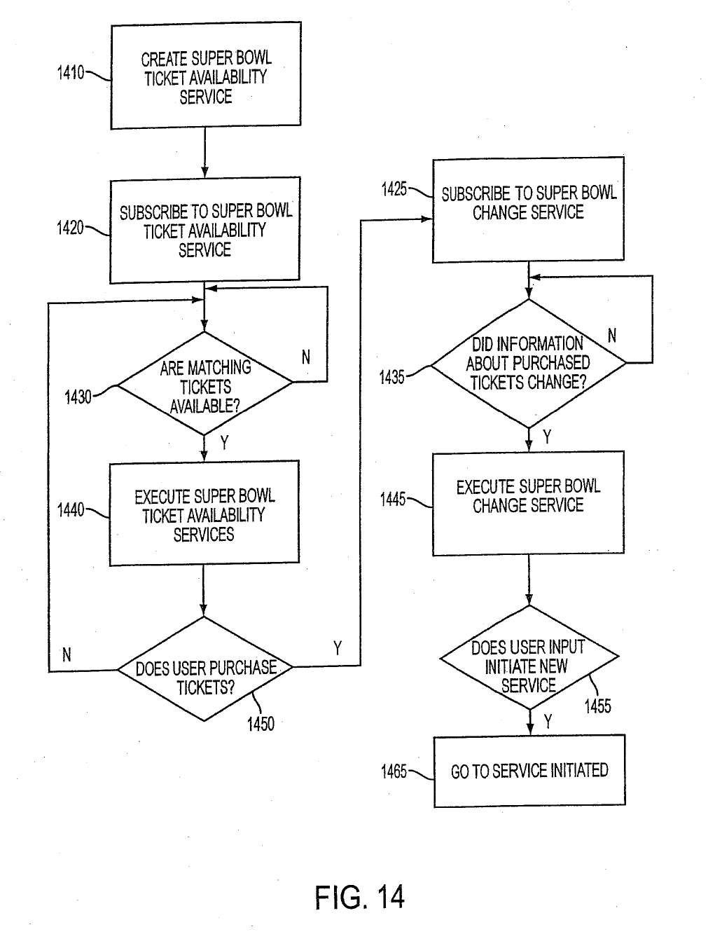

Upon completion of the entertainment service, step 950 preferably makes a determination of whether the user input initiates a new service subscription. If the user input does not initiate a new service, the system returns to step 930. If the user input initiates a new service, the system returns to step 920. Step 920 is discussed further below in relation to FIG. 14. The user's subscription to an original entertainment service may or may not be terminated, and the personal profile may or may not be modified based upon the user input. Whether changes are made may be based upon the personal profile, the characteristics attributed to the entertainment service by the service creator, or other criteria. For example, once a user has purchased tickets for the Super Bowl, the user may not wish to receive additional information relating to the availability of Super Bowl tickets (service termination), or may wish to receive only additional information relating to better tickets (personal profile modification). User input may also lead to other changes in the system, including changes in the characteristics attributed to the entertainment service.

For example, in a preferred embodiment, if a high percentage of users subscribed to a particular entertainment service modify their personal profile in a particular manner, the entertainment service may be automatically updated to simplify that modification. For example, if 30% of subscribers to an entertainment service change their personal profile so that notification occurs by both telephone and personal digital assistant, the entertainment service may provide a shortcut to changing the personal profile placed on the initial menu option. For example, a user may receive an initial menu option stating “Hello Joe, there are two Super Bowl tickets meeting your criteria (press 1) and there is a simple way to also receive telecaster information on your PDA (press 2).”

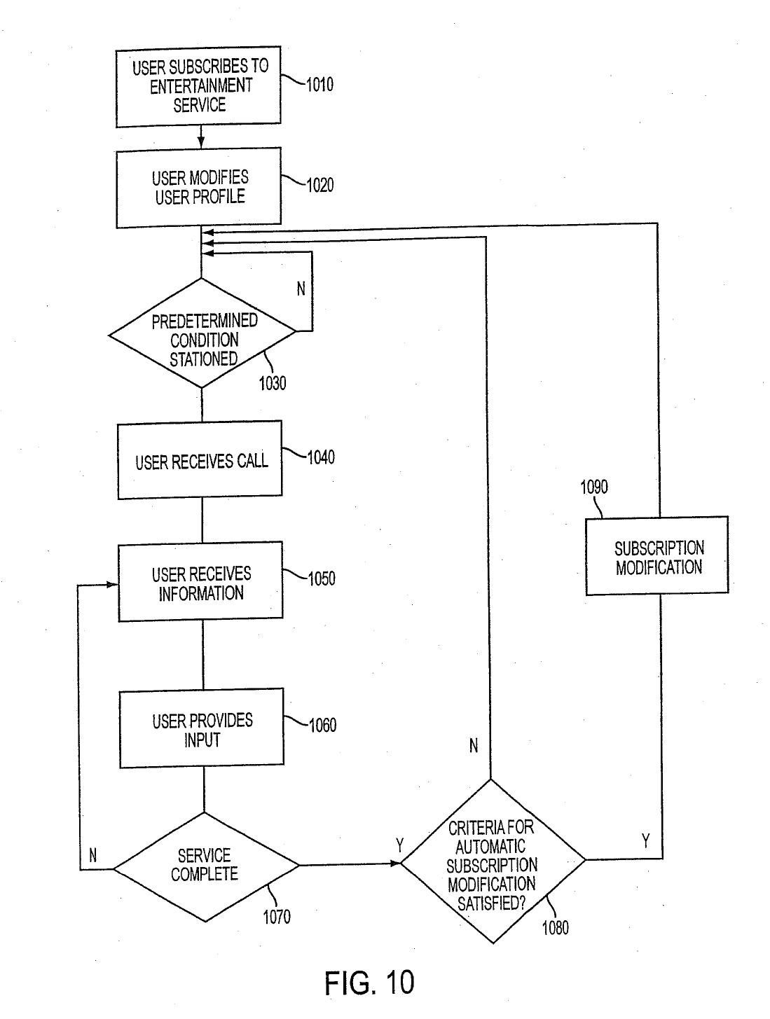

FIG. 10 is a flow chart of a method in accordance with an embodiment of the invention relating to entertainment services from the user perspective. At step 1010, a user subscribes to an entertainment service. At step 1020, a user may modify the personal is profile. A data source may be monitored at step 1030 to determine whether the scheduling condition has been satisfied. Once the scheduling condition has been satisfied, the user receives a call at step 1040. A user then receives information at step 1050 and provides input at step 1060. If the service is not complete, the system preferably returns to step 1050. If the service is complete, the system may determine whether the user should be automatically subscribed to a new service based upon the user input at step 1080. The system then monitors the data source to determine when the predetermined condition has been satisfied at step 1030. Each of these steps is explained in more detail below.

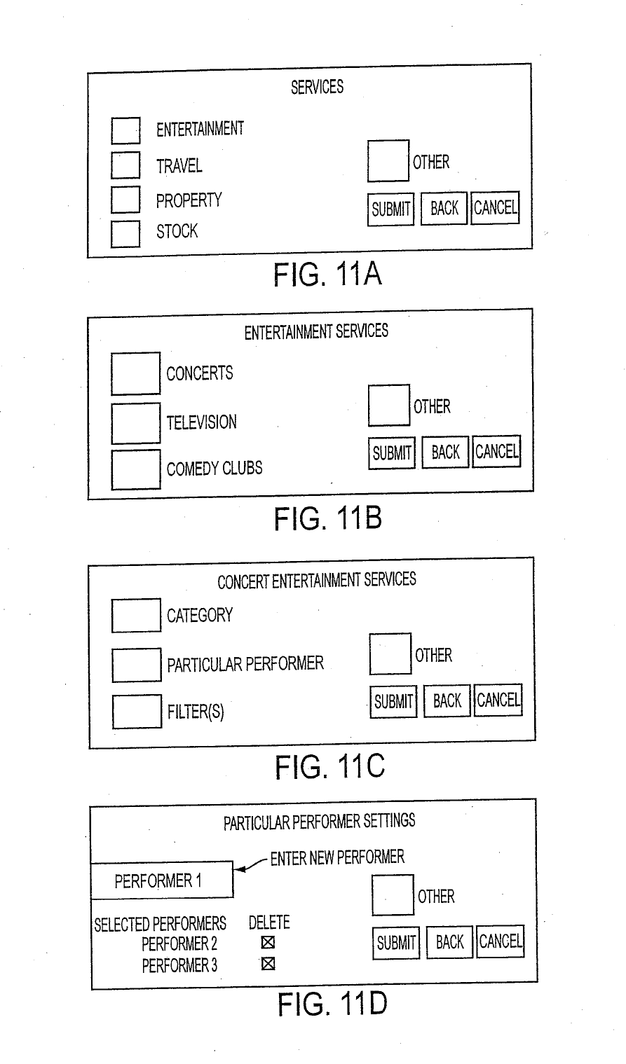

According to a preferred embodiment, a user subscribes to an entertainment service at step 1010. In a preferred embodiment, a user would not be subscribed to a service without indicating a desire to be subscribed to the service. In a preferred embodiment, a user may register through a series of GUIs on a networked computer terminal as depicted in FIGS. 11(a) and 11(b). FIG. 11(a) represents an initial GUI by which a user may register with a number of different types of services, including entertainment services. FIG. 11(b) represents a possible GUI that the user would see after selecting an entertainment service. More specific services, such as services within the concerts category, may also be developed. In addition to subscribing by a networked computer terminal, subscription may be made by telephone, PDA, computer or other terminal device, as well as through non-electronic medium, such as mail. As stated previously, the service creator or the user may also establish a system whereby predetermined user input automatically subscribes the user to a particular entertainment service. In a preferred embodiment, entertainment services are created by an service creator, however it is also possible for the user to create an entertainment service if none of the entertainment services available reflect the interests of the particular user.

Once the user has subscribed to an entertainment service, the user may establish a personal profile for the particular service at step 1020. In a preferred embodiment, the user may modify the personal profile through a number of GUIs on a computer terminal as depicted in FIGS. 11(c) and 11(d). In a preferred embodiment, the user may simultaneously subscribe to a combination of services and establish a single personal profile that would be associated with each of the subscribed services.

At step 1030, the system preferably monitors a data source to determine whether the predetermined condition has been satisfied. If not, the system does not proceed to step 1040, but continues to monitor the data source. If the predetermined condition is satisfied, the system proceeds to step 1040. At step 1040, the user receives a call from a system, such as a system described below with reference to FIGS. 1-8. In a preferred embodiment, the call may be received at a telephone, a PDA, a two-way pager, a computer terminal, or other two-way communication enabled device. Additionally, the user may preferably be able to receive a call at a combination of devices, or in a particular order. For example, a user may elect to receive notification first at an office phone and, if that call is not received, then to a cell phone.

At step 1050, the user receives information. The information received initially may include a greeting, a brief statement about the information of the entertainment service, and other information. In a preferred embodiment, the user may select whether a personal identification number (“PIN”) must be entered prior to receiving information. A PIN may be required only prior to receiving confidential information or purchasing items above a certain cost.

After receiving the information, the system proceeds to step 1060. At step 1060, the user provides input. This input may include a request for new or repeated information, or may include a request to purchase or otherwise act on that entertainment opportunity. All user input may be written to a data file upon receipt by the system. At step 1070, the system determines whether the service is complete. If the service is not complete, the system returns to step 1050 and provides the user with the requested information. If the service is complete, the system determines whether criteria for automatic subscription modification have been satisfied. For example, a user may be removed from the present service, subscribed to a new service, or have the personal profile settings adjusted based upon the user input. Upon completion of step 1080, the system returns to monitoring the data source at step 1030.

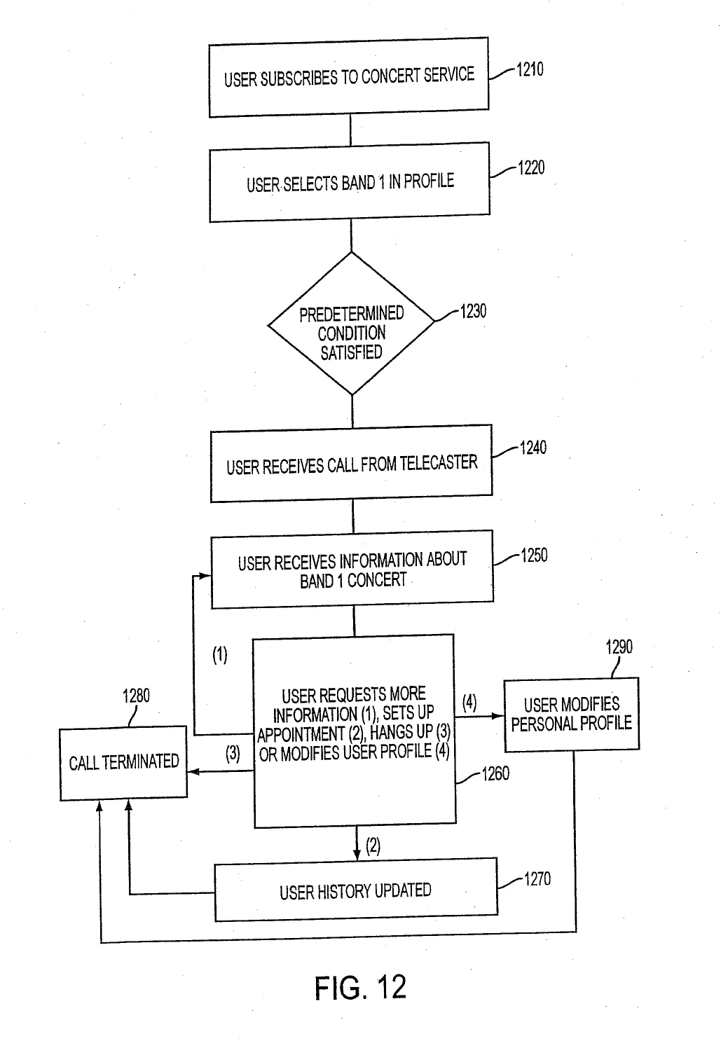

FIG. 12 is an exemplary flow chart of a user interaction with a concert entertainment service. After subscribing to a concert entertainment service in step 1210, the user selects a particular band in the personal profile at step 1220. At step 1230, the data source is monitored to determine whether, for example, there is an upcoming concert by Band 1. Once the predetermined condition is satisfied, the user may be called in accordance with the personal profile at step 1240. At step 1260, the user provides input. In a preferred embodiment, the user may request additional information, buy tickets, hang up, or modify the personal profile. Other input options are preferably available.

If the user requests additional information, the system may return to step 1250. For example, one option provided by the system may be the opportunity to hear a sound clip of an artist who will be performing at a local tavern the following weekend. The user may indicate that such information is desired by providing a predetermined input, and the system may provide the requested sound clip. Additionally, the user may request that such information is provided to another terminal device. For example, the user may request that a track from the artists album be mailed to an email address associated with the user.

If the user buys a ticket, the system updates the purchase history record for the user at step 1270 and the call may be terminated at step 1280. In a preferred embodiment, a user buying tickets may be able to further query the data source regarding the tickets and the entertainment opportunity if the user desires. The user may also request a ticket to be delivered to the user. For example, a user may request an electronic ticket to be delivered to the user's email account, a ticket delivered to the user's address, or other request.

If the user hangs up, the call is terminated at step 1280. In a preferred embodiment, the system may update the personal profile, the user history, both, or other information based upon a terminated call. In a preferred embodiment, a user may elect to modify the personal profile during a call at step 1290. For example, if the user receives information that is of no interest to the user, it is possible to change the personal profile so that such information may not be provided to the user in the future.

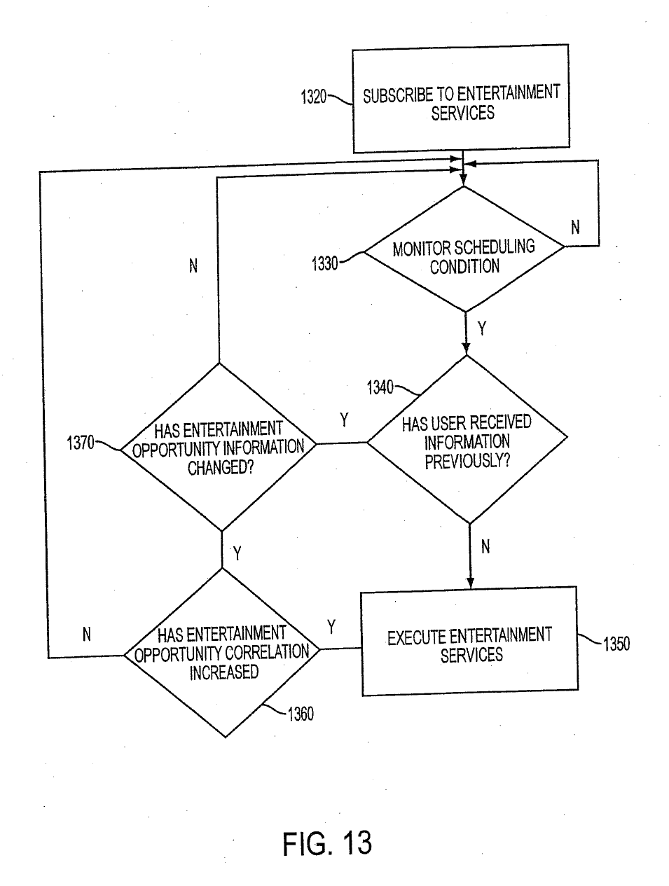

FIG. 13 is a flow chart of a method in accordance with an embodiment of the invention relating to changed information about entertainment opportunities. In a preferred embodiment, a user may not be offered repeated entertainment information if the user indicates that repeated entertainment information is not desired. At step 1320, the user subscribes to an entertainment service. At step 1330, the system preferably monitors the data source for the satisfaction of the predetermined condition as previously disclosed.

In a preferred embodiment, the system determines whether the user has previously received information at step 1340. For example, the system may compare the service information with the user history to determine whether the user has been offered the information previously. If the user has not received the information, the system proceeds to step 1350 and the entertainment service is executed. If the user has received related information previously, the system determines whether the entertainment opportunity information has changed since the previous transmission. If it has not changed, then the system preferably returns to monitoring the data source at step 1330.

If the information has changed, the system may determine whether the entertainment opportunity correlation has increased or decreased at step 1370. For example, if the price of the entertainment opportunity has decreased by half, an entertainment service may be executed at step 1350. In a preferred embodiment, entertainment services having changed information might have a different content than entertainment services having new information. For example, the initial dialogue may include less information about the entertainment opportunity, and a brief description that the price had decreased by half.

In a preferred embodiment, entertainment services may include both new information and previously disclosed information. Additionally, a user may be able to access information that has not been provided in accordance with the filtering process depicted in FIG. 13. For example, if a user received information relating to an entertainment opportunity but there was initially a scheduling, conflict that was later resolved, the user might want to access the filtered information.

FIG. 14 is a flow chart of a method in accordance with an embodiment of the invention relating to subscription to a new service based upon user input. More particularly, FIG. 14 depicts an instance in which a user is automatically subscribed to a new service based upon the purchase of tickets through an entertainment service. As stated previously, in a preferred embodiment, subscription is completely dependent upon affirmative selections made by the user. Specifically, the user may be subscribed to a new service only if the user has indicated that a particular type of user input received warrants a new service.

In FIG. 14, a service is created titled “Super Bowl Ticket Availability” service at step 1410. A user subscribes to the service at step 1420. At step 1430, the system monitors the data source as previously disclosed. For example, the system may periodically run an OLAP report containing requests for certain types of data as described in detail below with respect to FIGS. 1-8. After determining that tickets are available, the system executes the entertainment service at step 1440.

In a preferred embodiment, if the user purchases tickets, a user may automatically be subscribed to another service, the Super Bowl change service, which provides information about cancellations and delays, for example. Depending on the desires of the user, as represented through a personal profile for example, the user may also be automatically unsubscribed from the “Super Bowl Ticket Availability” service.

In a preferred embodiment, the system may allow users to participate in a phone auction. A user may be notified of the availability of a particular entertainment opportunity by a telecast and given the option of submitting a bid. The system may automatically award the entertainment opportunity based on the input received by various users.

In one embodiment, the system may provide entertainment opportunity related information. For example, after purchasing a ticket to a concert, the system may query whether the user wants directions to the concert. If the user indicates that such information is desired, the system may further query the method by which the user would like to receive the information. For example, the system may ask “would you like me to tell you the directions (press 1), send the directions to your house (press 2), or email the directions to you (press 3)?”

In a preferred embodiment, the entertainment services may be associated with a user calandering function. For example, a user may provide calendar information or access to an entertainment services provider who may integrate that information into the entertainment services. For example, an entertainment service would not provide information about an event that was going to take place when the user was out of town. This embodiment may also provide information about entertainment opportunities while traveling.

In a preferred embodiment, more than one user may subscribe to an entertainment service together. For example, a group of friends may subscribe to a Friday night entertainment service together. In this embodiment, each of the personal profiles and other user information may be accessed in determining what entertainment opportunities should be identified in the entertainment service. Additionally, input information provided by the other members may be automatically delivered as such input information becomes available.

According to one embodiment of the present invention, a system is provided for automatic, interactive, real-time, voice transmission of OLAP output to one or more subscribers. For example, subscribers may be called by the system, and have content delivered audibly over the telephone or other voice-enabled terminal device. During the IVB, information may be exchanged between the system and a subscriber. The system conveys content to the subscriber and, the subscriber may respond by pressing one or more buttons on a telephone touch pad dial (or other input mechanism) to hear more information, to exercise options, or to provide other responses. This interaction shapes the structure of a basic exchange between the system and the subscriber. During or after the call is terminated, the subscriber's responses may be stored and processed (e.g., by other applications).

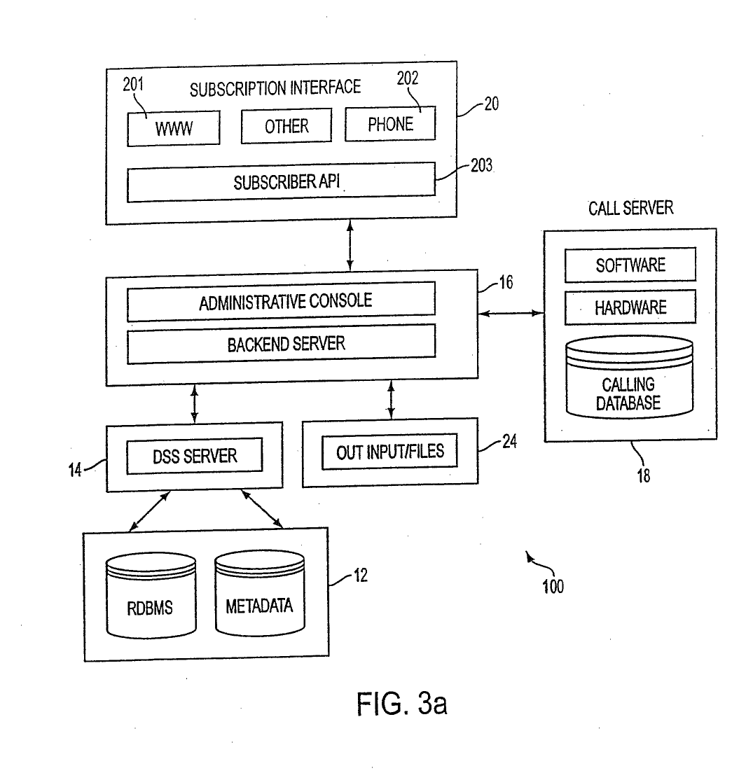

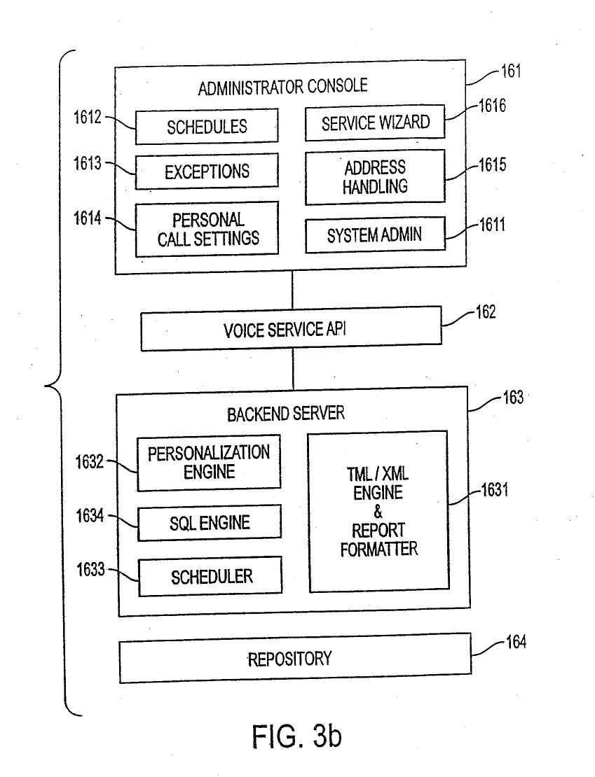

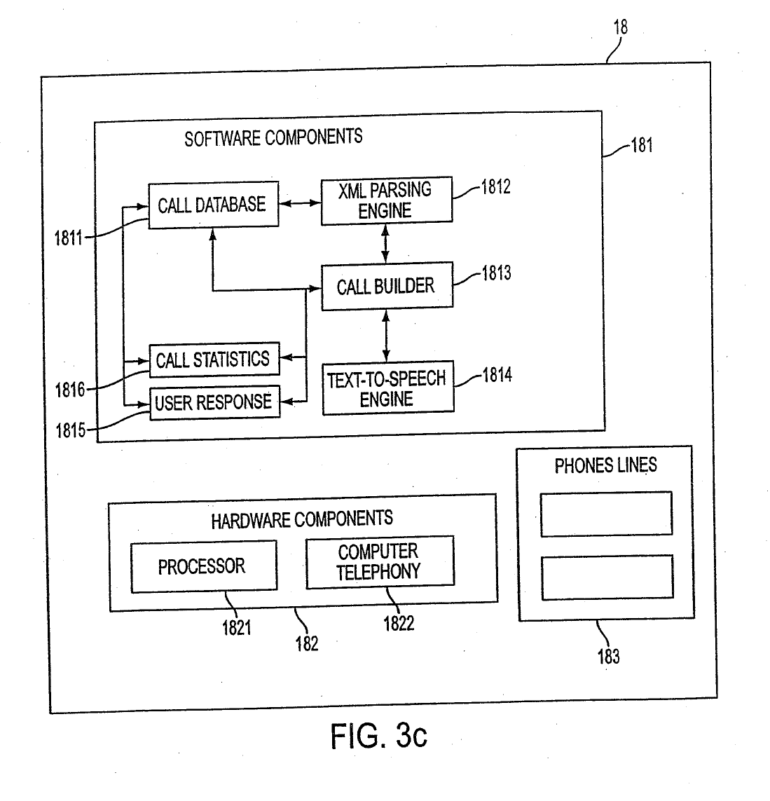

According to one embodiment of the present invention, a method for automatic, interactive, real-time, voice transmission of OLAP output to one or more subscribers is provided. FIG. 1a depicts a flow chart of a method for automatic, interactive, real-time, voice transmission of OLAP output according to one embodiment. The method begins in step 110 with the creation of a voice service (e.g., by a system administrator or user). A voice service is created using, for example, a voice service wizard which may comprise a series of interfaces. One embodiment of a method for creating a voice service is explained in more detail below in conjunction with FIG. 1b. One embodiment of a voice service wizard is explained below in conjunction with FIG. 3b.

After a voice service is created, users may subscribe or be subscribed to the voice service (step 120), for example, by using a subscription interface. According to one embodiment, users may subscribe to an existing voice service over the telephone or by web-based subscription. A user may also be subscribed programmatically. In other embodiments, a user may subscribe to a voice service via electronic mail. Not every voice service created in step 110 is available for subscription. More specifically, according to another embodiment, only a user with appropriate access, such as the creator of the service, is allowed to subscribe himself or others to a service. Such a security feature may be set when the voice service is created.

In step 130, a scheduling condition or other predetermined condition for the voice services is monitored to determine when they are to be executed. That is, when a voice service is created or subscribed to, the creator or user specifies when the voice service is to be executed. A user may schedule a voice service to execute according to the date, the time of day, the day of the week, etc. and thus, the scheduling condition will be a date, a time, or a day of the week, either one time or on a recurring basis. In the case of an alert service, discussed in more detail below, the scheduling condition will depend on satisfaction of one or more conditions. According to one embodiment, the condition(s) to be satisfied is an additional scheduling condition. According to another embodiment, to another embodiment, a service may be executed “on command” either through an administrator or programmatically through an API. Scheduling of voice services is discussed in more detail below.

The method continues monitoring the scheduling condition for voice services until a scheduling condition is met. When a scheduling condition is met, that voice service is executed. The execution of a voice service involves, inter alia, generating the content for the voice service, and structuring the voice service to be telecast through a call server. The execution of a voice service is explained in detail in conjunction with FIG. 1c.

An example of a telecast is as follows.
PERSONALIZED GREETING
Hello Joe, this is your stock update.
PIN VERIFICATION
Please enter your six digit PIN number
(Joe enters his PIN, using the keypad dial on his telephone.)
MENU OPTIONS
Your portfolio was up by $1000 today.
Please select:
1. To get a portfolio stock update
2. To conduct a transaction
(Joe presses 2)
SUB MENU
Thank you, Joe! Please select a ticker.
1. PQT
2. TQP
3. Listen to options again
4. Return to main menu
(Joe presses 1.)
SUB MENU
Would you like to buy or sell stock? Please press:
1. To sell stock
2. To buy stock
(Joe presses 1.)
SUB MENU
How many shares of PQT would you like to sell today? Please press:
1. To sell 50 shares
2. To sell 100 shares
3. To sell 200 shares
4. To sell another quantity
(Joe presses 2.)
SUB MENU
You selected 2. You want to sell 100 shares of PQT. Please press:
1. If this is correct
2. If this is incorrect
3. If you want to change the number of shares you want to buy.
(Joe presses 1.)
END VOICE SERVICE/TERMINATE TELECAST
Thank you for using our voice interactive broadcasting service, Joe. We will call you
back when your transaction is completed. Good-bye.
   As can be seen from the above sample during an IVB, the user is presented with information, e.g., the status of his portfolio, and is presented options related to that report, e.g., the option to buy or sell stock.

According to one embodiment, a voice service is constructed using service wizard. A voice service is constructed using several basic building blocks, or elements, to organize the content and structure of a call. According to one embodiment, the building blocks of a voice service comprise elements of a markup language. According to one particular embodiment, elements of a novel markup language based on XML (TML) are used to construct voice services. Before explaining how a telecast is constructed, it will be helpful to define these elements.

The DIALOG element is used to define a unit of interaction between the user and the system and it typically contains one or more of the other elements. A DIALOG can not be contained in another element.

The SPEECH element is used to define text to be read to a user.

The INPUT element is used to define a section of a DIALOG that contains interactive elements, i.e., those elements that relate to a response expected from a user and its validation. An INPUT element may contain OPTION, PROMPT and ERROR elements.

An OPTION element identifies a predefined user selection that is associated with a particular input. According to one embodiment, OPTION elements are used to associate one or more choices available to a user with telephone keys.

A PROMPT element defines a particular input that is expected. According to one embodiment, a PROMPT element defines that a sequence or number of key presses from a telephone keypad is expected as input. Unlike an OPTION Element, a PROMPT Element is not associated with predefined user selections.

The PROMPT and OPTION elements may also be used to request user input using natural language. According to one embodiment, speech recognition technology is used to enable a user to respond to a PROMPT element or to select an OPTION element verbally by saying a number, e.g., “one.”. The verbal response is recognized and used just as a keypress would be used. According to another embodiment, the user may provide a free form verbal input. For example, a PROMPT element may request that a user enter, e.g., the name of a business. In response the user speaks the name of a business. That spoken name is then resolved against predetermined standards to arrive at the input. Word spotting and slot filling may also be used in conjunction with such a PROMPT to determine the user input. For example, a PROMPT may request that the user speak a date and time, e.g., to choose an airline flight or to make a restaurant reservation. The user's spoken response may be resolved against known date and time formats to determine the input. According to another embodiment, a PROMPT is used to request input using natural language. For instance, in conjunction with a voice service to be used to make travel plans, instead of having separate PROMPT elements request input for flight arrival, departure dates and locations, a single natural language PROMPT may ask, “Please state your travel plan.” In response, the user states ‘I’d like to go from Washington D.C. to New York city on the 3^{rd} of January and return on the 3^{rd} of February. This request would be processed using speech recognition and pattern matching technology to derive the user's input.

The ERROR element is used to define the behavior of the system if a user makes an invalid response such as touching a number that has not been associated with an OPTION element, or entering input that does not meet the criteria of a PROMPT element. A SYS-ERROR element defines a handler for certain events, such as expiration of the waiting time for a user response.

The FOR-EACH element is used to direct the system to loop through a list of variables e.g., variables contained in a database report, or variables from a user input, to dynamically generate speech from data.

In addition to the elements described above, there are two features that maximize an administrator's ability to design voice services. Call Flow Reports enable an administrator to generate the structure of a call based on the content of an report e.g., from an OLAP system or other data repository. For example, the options presented to a user in a PROMPT element may be made to correspond to the row of a data report. According to one embodiment, report data is converted into options by application of an XSL (extensible style sheet language) style sheet. The result of this application is inserted into the static call structure when the voice service is executed.

The use of an XSL style sheet is a feature that maximizes an administrator's voice service building ability. As discussed above, they are used to create dynamic call structure that depends on data report output. They may also be used to generate a text string that comprises the message to be read to a user at any point in a call.

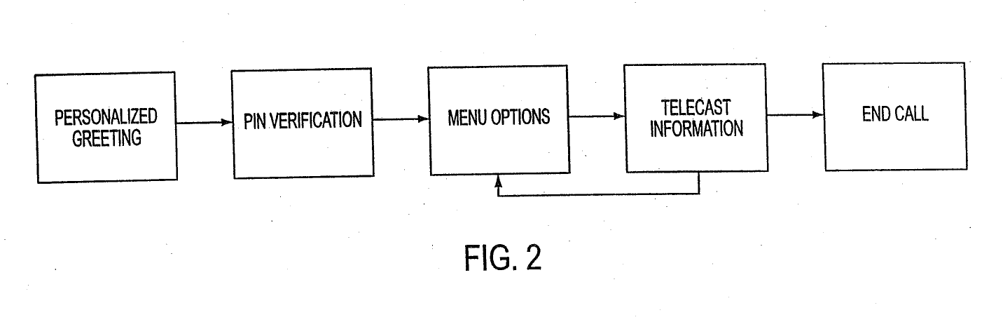

A method for creating a voice service according to one embodiment will now be explained in conjunction with FIG. 2. The method begins in step 210 by naming the voice service. Then, in step 220 various scheduling parameters of the voice service are defined. In step 250 the service content is defined. And, in step 260, the personalization modes, or style properties are selected for the voice service.

According to one embodiment, in step 210, a voice service is named and a description of the voice service provided. By providing a name and description, a voice service may be uniquely identified. An interface is provided for prompting input of the name of the service to be created or edited. An input may also be provided for a written description. An open typing field would be one option for providing the description input. According to another embodiment, if an existing call service has been selected to edit, the service name field may not be present or may not allow modification.

In step 220, conditions for initiating the service are selected. This may include selecting and defining a service type. At least two types of services may be provided based on how the services are triggered. A first type of service is run according to a predetermined schedule and output is generated each time the service is run. A second type of service, an alert service, is one that is run periodically as well, however, output is only generated when certain criteria is satisfied. Other service types may be possible as well. In one embodiment the administrator is prompted to choose between a scheduled service or an alert service. An interface may provide an appropriate prompt and some means for selecting between a scheduled service and an alert service. One option for providing the input might be an interface with a two element toggle list.

In one embodiment, a set of alert conditions is specified to allow the system to evaluate when the service should be initiated if an alert type service has been selected. In one embodiment, a report or a template/filter combination upon which the alert is based is specified. Reports and template/filter combinations may be predefined by other objects in the system including an agent module or object creation module. According to one embodiment, an agent module, such as DSS Agent™ offered by MicroStrategy, may be used to create and define reports with filters and template combinations, and to establish the alert criteria for an alert service. According to another embodiment, an interface is be provided which includes a listing of any alert conditions presently selected for the voice service. According to this embodiment, the interface may comprise a display window. A browse feature may take the user to a special browsing interface configured to select a report or filter-template combination. One embodiment of an interface for selecting reports and filter-template combinations is described below. Once a report or filter and template combination is chosen, the alerts contained in the report or filter and template combination may be listed in the display window of the interface.

In step 220, the schedule for the service is also selected. According to one embodiment, predefined schedules for voice services may be provided or a customized schedule for the voice service may be created. If a new schedule is to be created, a module may be opened to enable the schedule name and parameters to be set. Schedules may be run on a several-minute, hourly, daily, monthly, semi-annual, annual or other bases, depending upon what frequency is desired. According to one embodiment, an interface is provided that allows the administrator to browse through existing schedules and select an appropriate one. The interface may provide a browsing window for finding existing schedule files and a “new schedule” feature which initiates the schedule generating module. In one embodiment, schedules may not be set for alert type services. However, in some embodiments, a schedule for evaluating whether alert conditions have been met may be established in a similar manner.

In step 220, the duration of the service is also set. Service duration indicates the starting and stopping dates for the service. Setting a service duration may be appropriate regardless of whether a scheduled service or alert type service has been selected. The start date is the base line for the scheduled calculation, while the end date indicates when the voice service will no longer be sent. The service may start immediately or at some later time. According to one embodiment, interface is provided to allow the administrator to input start and end dates. The interface may also allow the administrator to indicate that the service should start immediately or run indefinitely. Various calendar features may be provided to facilitate selection of start and stop dates. For example, a calendar that specifies a date with pull-down menus that allow selection of a day, month and year may be provided according to known methods of selecting dates in such programs as electronic calendar programs and scheduling programs used in other software products. One specific aid that may be provided is to provide a calendar with a red circle indicating the present date and a blue ellipse around the current numerical date in each subsequent month to more easily allow the user to identify monthly intervals. Other methods may also be used.

In step 220, a voice service may also be designated as a mid-tier slicing service. In one embodiment, mid-tier slicing services generate content and a dynamic subscriber list in a single query to an OLAP system. According to one embodiment, in a mid-tier slicing service a single database query is performed for all subscribers to the service. The result set developed by that query is organized in a table that contains a column that indicates one or more users that each row of data is applicable to.

In step 250, the content of the voice service is defined. Defining the content of the voice service may include selecting the speech to be delivered during the voice service broadcast (content), the structure of dialogs, menus, inputs, and the background procedures which generate both content and structure. In one embodiment, defining voice service content establishes the procedures performed by the vss server to assemble one or more active voice pages in response to initiation of the voice service. According to one embodiment, defining service content involves establishing a hierarchical structure of TML elements which define the structure and content of a voice service. All of the elements in a given service may be contained within a container.

The personalization type is selected in step 260. Personalization type defines the options that the administrator will have in applying personalization filters to a voice service. According to one embodiment, a personalization filter is a set of style properties that can be used to determine what content generated by the service will be delivered to the individual user and in what format it will be delivered. In one embodiment, personalizing the delivery format may include selection of style properties that determine the sex of the voice, the speed of the voice, the number of call back attempts, etc. Personalization filters may exist for individual users, groups of users, or types of users. According to one embodiment, personalization filters may be created independent of the voice service. According to this embodiment, a voice service specifies what filters are used when generating IVBs. Some personalization type options may include: allowing no personalization filters; allowing personalization filters for some users, but not requiring them; and requiring personalization filters for all interactive voice broadcasts made using the service.

According to one embodiment, specifying personalization type is accomplished by administrator input through an interface. The interface may offer a toggle list with the three options: required personalization, optional personalization, and no personalization.

The voice service may be stored in a database structure to enable users to retrieve predefined voice services and to subscribe to these services, for example, through subscription interfaces explained in conjunction FIGS. 3a-3c or otherwise. An interface informing the administrator that creation of the voice service is complete may also be provided.

According to one embodiment, the method of FIG. 1b also comprises an error condition step. An error condition step may be used to enable administrators to specify “error” conditions and the handling of those conditions. For example, an “error” condition may comprise a notification that a server is “down” or that there is no data to be returned. An administrator may specify particular actions to be performed by the system in response to one or more error conditions. For example, an administrator may specify an “addressing” error (e.g., disconnected number) and indicate a particular action to be performed in response to an “addressing” error (e.g., notify system administrator). Other error conditions might include: an alert report encountering an error and returning no data; a subscriber lacking the required personalization filter for the service; errors occurring in the generation of one or more reports; or reports returning no data. Various other conditions and actions may be specified. Certain error conditions may be predetermined for the system, but an administrator may have reasons for supplementing or diverging from the predetermined error conditions. According to one particular embodiment, error conditions are specified using the ERROR and SYS-ERROR elements.

In one embodiment, setting error conditions may be accomplished using an error handling interface. The interface may allow the administrator to select either default error handling, or to customize error handling using a module for defining error handling. If default handling is selected, the system uses established settings. If customized handling is chosen, the user may use a feature to access the appropriate interface for the error handling module.

Servers may have limited capacity to perform all of the actions required of them simultaneously, the method of FIG. 1b comprises a step for prioritizing the execution and delivery of voice services. Prioritization may establish the order in which the voice service system allocates resources for processing voice service and delivering the IVB. According to one embodiment, assigning priority to a voice service establishes priority for queries to the database system, formatting the voice service, or IVBs. Any criteria may be used for establishing priority. According to one embodiment, priority is established based on service content. According to another embodiment, priority is based on service destination. According to another embodiment, priority may be established based on the type of voice service, i.e., alert vs. scheduled. Any number of procedures or criteria for denoting relative importance of service delivery may be established.

In one embodiment, an interface is provided for defining the priority of the voice service being created or edited. According to one embodiment, the interface comprises a screen including option boxes with pull down menus listing the number of different prioritization options.

Another aspect of the invention relates to a method for executing a voice service. FIG. 1c depicts one example of a flow chart for executing a voice service. In step 310, the content of a voice service is generated. In step 320, the call structure of a telecast is created via Active Voice Pages. In step 330, the AVPs are put in a call database for processing e.g., in a call queue. In step 340, the call request is processed and an interactive voice broadcast with the user is implemented. In step 350, user's responses are written back to the voice service system (e.g., the Active Voice Page). Each of these steps will be explained in more detail below.

According to one embodiment, content is created in step 310 as follows. A voice service execution begins by running scheduled reports, queries or by taking other action to determine whether the service should be sent. The subscribers for the service are then resolved. Datasets are generated for each group of subscribers that has unique personalization criteria.

Call structure may be created (step 320) as follows. An AVP contains data at various hierarchical content levels (nodes) that can be either static text or dynamic content. Static text can be generated e.g., by typing or by incorporating a text file. Dynamic content may be generated e.g., by inserting data from a data report using a grid an/or an XSL stylesheet. Moreover, content is not limited to text based information. Other media, such as, sound files, may be incorporated into the AVP. The call data (for example, at a particular level) may be the text that is converted to speech and played when the recipient encounters the node.

According to another embodiment, call content may include “standard” active voice pages that are generated and inserted into a database or Web Server where the pages are periodically refreshed. According to one particular embodiment, the active voice page that is generated for a user contains links to these standard active voice pages. The links may be followed using a process similar to web page links.

The call structure may comprise either a static structure that is defined in the voice service interfaces e.g., by typing text into a text box and/or a dynamic structure generated by grid/XSL combinations. The dynamic structure is merged with static structure during the service execution. A single call structure is created for each group of users that have identical personalization properties across all projects because such a group will receive the same content.

After a call structure is generated, in step 330, it is sent to a call database e.g., call database 1811 shown in FIG. 3c along with the addresses and style properties of the users. The style properties govern the behavior of a call server 18 in various aspects of the dialog with a user. Call server 18 queries call database 1811 for current call requests and places new call requests in its queue.

In step 340, a call request is processed. A call is implemented on call server 18 using one of several ports that are configured to handle telephone communication. When a port becomes available, the coil request is removed from the queue and the call is made to the user. As the user navigates through an active voice page, e.g., by entering input using the key pad or by speaking responses, call/content is presented by converting text to speech in text-to-speech engine 1814. User input during the call may be stored for processing. According to another embodiment, user responses and other input may also be used to follow links to other active voice pages. For example, as explained above, “standard” active voice pages may be generated and inserted into a database or Web Server. Then, when a user's voice service is delivered, that voice service may contain links to information that may be accessed by a user. A user may access those standard active voice pages by entering input in response to OPTION or PROMPT elements.

In step 350, user responses are stored by the system. According to one embodiment, user responses are stored in a response collection defined by the active voice page. A voice service may specify that a subscriber return information during an IVB so that another application may process the data. For instance, a user may be prompted to purchase a commodity and be asked to enter or speak the number of units for the transaction. During or after an IVB, the subscriber's responses are written to a location from which they can be retrieved for processing (e.g., by an external application).

FIG. 2 is an example of an IVB with interactive call flow. An IVB usually contains a greeting message that addresses the targeted user, identifies the name of the calling application, and states the purpose of the call and/or presents summary metrics. The voice service system can also implement a PIN verification protocol, if this layer of security is required. The main menu structure of an IVB can contain a number of options that lead to sub-menu structures. A menu can also contain prompts for the user to enter numerical information using, a telephone touch pad dial. A node along the hierarchical menu structure may have options to return the user to a higher level.

FIG. 3 depicts an embodiment of a system according to one embodiment of the present invention. Preferably, the system comprises database system 12, a DSS server 14, voice service server 16, a call server 18, subscription interface 20, and other input/files 24.

Database system 12 and DSS server 14 comprise an OLAP system that generates user-specified reports from data maintained by database system 12. Database system 12 may comprise any data warehouse or data mart as is known in the art, including, a relational database management system (“RDBMS”), a multidimensional database management system (“MDDBMS”) or a hybrid system. DSS server 14 may comprise an OLAP server system for accessing and managing data stored in database system 12. DSS server 14 may comprise a ROLAP engine, MOLAP engine or a HOLAP engine according to different embodiments. Specifically, DSS server 14 may comprise a multithreaded server for performing analysis directly against database system 12. According to one embodiment, DSS server 14 comprises a ROLAP engine known as DSS Server™ offered by Micro Strategy.

Voice service server (VSS) 16, call server 18 and subscription interface 20 comprise a system through which subscribers request data and reports e.g., OLAP reports through a variety of ways and are verbally provided with their results through an IVB. During an IVB, subscribers receive their requested information and may make follow-up requests and receive responses in real-time as described above. Although the system is shown, and will be explained, as being comprised of separate components and modules, it should be understood that the components and modules may be combined or further separated. Various functions and features may be combined or separated

Subscription interface 20 enables users or administrators of the system to monitor and update subscriptions to various services provided through VSS 16. Subscription interface 20 includes a world wide web (WWW) interface 201, a telephone interface 202, other interfaces as desired and a subscriber API 203. WWW interface 201 and telephone interface 202 enable system 100 to be accessed, for example, to subscribe to voice services or to modify existing voice services. Other interfaces may be used. Subscriber API 203 provides communication between subscription interface 20 and VSS 16 so that information entered through subscription interface 20 is passed through to VSS 16.

Subscription interface 20 is also used to create a subscriber list by adding one or more subscribers to a service. Users or system administrators having access to VSS 16 may add multiple types of subscribers to a service such as a subscriber from either a static recipient list (SRL) (e.g., addresses and groups) or a dynamic recipient list (DRL) (described in further detail below). The subscribers may be identified, for example, individually, in groups, or as dynamic subscribers in a DRL. Subscription interface 20 permits a user to specify particular criteria (e.g., filters, metrics, etc.) by accessing database system 12 and providing the user with a list of available filters, metrics, etc. The user may then select the criteria desired to be used for the service. Metadata may be used to increase the efficiency of the system.

A SRL is a list of manually entered names of subscribers of a particular service. The list may be entered using subscription interface 20 or administrator console 161. SRL entries may be personalized such that for any service, a personalization filter (other than a default filter) may be specified. A SRL enables different personalizations to apply for a login alias as well. For example, a login alias may be created using personalization engine 1632. Personalization engine 1632 enables subscribers to set preferred formats, arrangements, etc. for receiving content. The login alias may be used to determine a subscriber's preferences and generate service content according to the subscriber's preferences when generating service content for a particular subscriber.

A DRL may be a report which returns lists of valid user names based on predetermined criteria that are applied to the contents of a database such as database system 12. Providing a DRL as a report enables the DRL to incorporate any filtering criteria desired, thereby allowing a list of subscribers to be derived by an application of a filter to the data in database system 12. In this manner, subscribers of a service may be altered simply by changing the filter criteria so that different user names are returned for the DRL. Similarly, subscription lists may be changed by manipulating the filter without requiring interaction with administrator console 161. Additionally, categorization of each subscriber may be performed in numerous ways. For example, subscribers may be grouped via agent filters. In one specific embodiment, a DRL is created using DSS Agent offered by MicroStrategy.

VSS 16 is shown in more detail in FIG. 3b. According to one embodiment, VSS 16 comprises administrator console 161, voice service API 162 and backend server 163. Administrator console 161 is the main interface of system 100 and is used to view and organize objects used for voice broadcasting. Administrator console 161 provides access to a hierarchy of additional interfaces through which a system administrator can utilize and maintain system 100. Administrator console 161 comprises system administrator module 1611, scheduling module 1612, exceptions module 1613, call settings module 1614, address handling module 1615, and service wizard 1616.

System administrator module 1611 comprises a number of interfaces that enable selection and control of the parameters of system 100. For example, system administrator module 1611 enables an administrator to specify and/or modify an email system, supporting servers and a repository server with which system 100 is to be used. System administrator 1611 also enables overall control of system 100. For example, system administrator module is also used to control the installation process and to start, stop or idle system 100. According to one embodiment, system administrator 1611 comprises one or more graphical user interfaces (GUIs).

Scheduling module 1612 comprises a number of interfaces that enable scheduling of voice services. Voice services may be scheduled according to any suitable methodology, such as according to scheduled times or when a predetermined condition is met. For example, the predetermined condition may be a scheduled event (time-based) including, day, date and/or time, or if certain conditions are met. In any event, when a predetermined condition is met for a given service, system 100 automatically initiates a call to the subscribers of that service. According to one embodiment, scheduling module 1612 comprises one or more GUIs.

Exceptions module 1613 comprises one or more interfaces that enable the system administrator to define one or more exceptions, triggers or other conditions. According to one embodiment, exceptions module 1613 comprises one or more GUIs.

Call settings module 1614 comprises one or more interfaces that enable the system administrator to select a set of style properties for a particular user or group of users. Each particular user may have different options for delivery of voice services depending, on the hardware over which their voice services are to be delivered and depending on their own preferences. As an example of how the delivery of voice services depends on a user's hardware, the system may deliver voice services differently depending on whether the user's terminal device has voice mail or not. As an example of how the delivery of voice services depends on a user's preferences, a user may chose to have the pitch of the voice, the speed of the voice or the sex of the voice varied depending on their personal preferences. According to one embodiment, call settings module 1614 comprises one or more GUIs.

Address handling module 1615 comprises one or more interface that enable a system administrator to control the address (e.g., the telephone number) where voice services content is to be delivered. The may be set by the system administrator using address handling module 1615. According to one embodiment, address handling module 1615 comprises one or more GUIs.

Voice service wizard module 1616 comprises a collection of interfaces that enable a system administrator to create and/or modify voice services. According to one embodiment, service wizard module 1616 comprises a collection of interfaces that enable a system administrator to define a series of dialogs that contain messages and inputs and determine the call flow between these dialogs based on selections made by the user. The arrangement of the messages and prompts and the flow between them comprises the structure of a voice service. The substance of the messages and prompts is the content of a voice service. The structure and content are defined using service wizard module 1616.

Voice service API 162 (e.g., MicroStrategy Telecaster Server API) provides communication between administrator console 161 and backend server 163. Voice Service API 162 thus enables information entered through administrator console 161 to be accessed by backend server 163 (e.g., MicroStrategy Telecaster Server).

Backend server 163 utilizes the information input through administrator console 161 to initiate and construct voice services for delivery to a user. Backend server 163 comprises report formatter 1631, personalization engine 1632, scheduler 1633 and SQL engine 1634. According to one embodiment, backend server 163 comprises MicroStrategy Broadcast Server. Report formatter 1631, personalization engine 1632, and scheduler 1633 operate together, utilizing the parameters entered through administrator console 161, to initiate and assemble voice services for transmission through call server 18. Specifically, scheduler 1633 monitors the voice service schedules and initiates voice services at the appropriate time. Personalization engine 1632 and report formatter 1631 use information entered through service wizard 1616, exceptions module 1613, call settings module 1614, and address module 1615, and output provided by DSS server 14 to assemble and address personalized reports that can be sent to call server 18 for transmission. According to one embodiment, report formatter 1631 includes an XML based markup language engine to assemble the voice services. In a particular embodiment, report formatter includes a Telecaster Markup Language engine offered by MicroStrategy Inc. to assemble the call content and structure for call server 18.

SQL engine 1634 is used to make queries against a database when generating reports. More specifically, SQL engine 1634 converts requests for information into SQL statements to query a database.

Repository 164 may be a group of relational tables stored in a database. Repository 164 stores objects which are needed by system 100 to function correctly. More than one repository can exist, but preferably the system 100 is connected to only one repository at a time.

According to one embodiment, a call server 18 is used to accomplish transmission of the voice services over standard telephone lines. Call server 18 is shown in more detail in FIG. 3c: According to one embodiment, call server 18 comprises software components 181 and hardware components 182. Software components 181 comprise call database 1811, mark-up language parsing engine 1812, call builder 1813, text-to-speech engine 1814, response storage device 1815 and statistic accumulator 1816.

Call database 1811 comprises storage for voice services that have been assembled in VSS 16 and are awaiting transmission by call server 18. These voice services may include those awaiting an initial attempt at transmission and those that were unsuccessfully transmitted (e.g., because of a busy signal) and are awaiting re-transmission. According to one embodiment, call database 1811 comprises any type of relational database having the size sufficient to store an outgoing voice service queue depending on the application. Call database 1811 also comprises storage space for a log of calls that have been completed.

Voice services stored in call database 1811 are preferably stored in a mark-up language. Mark-up language parsing engine 1812 accepts these stored voice services and separates the voice services into parts. That is, the mark-up language version of these voice services comprises call content elements, call structure elements and mark-up language instructions. Mark-up language parsing engine 1812 extracts the content and structure from the mark-up language and passes them to call builder 1813.

Call builder 1813 is the module that initiates and conducts the telephone call to a user. More specifically, call builder dials and establishes a connection with a user and passes user input through to markup language parsing engine 1812. In one embodiment, call builder 1813 comprises “Call Builder” software available from Call Technologies Inc. Call builder 1813 may be used for device detection, line monitoring for user input, call session management, potentially transfer of call to another line, termination of a call, and other functions.

Text-to-speech engine 1814 works in conjunction with mark-up language parsing engine 1812 and call builder 1813 to provide verbal communication with a user. Specifically, after call builder 1813 establishes a connection with a user, text-to-speech engine 1814 dynamically converts the content from mark-up language parsing engine 1812 to speech in real time.

A voice recognition module may be used to provide voice recognition functionality for call server 181. Voice recognition functionality may be used to identify the user at the beginning of a call to help ensure that voice services are not presented to an unauthorized user or to identify if a human or machine answers the call. This module may be a part of call builder 1813. This module may also be used to recognize spoken input (say “one” instead of press “1”), enhanced command execution (user could say “transfer money from my checking to savings”), enhanced filtering (instead of typing stock symbols, a user would say “MSTR”), enhanced prompting, (saying numeral values).

User response module 1815 comprises a module that stores user responses and passes them back to intelligence server 16. Preferably, this is done within an AVP. During a telephone call, a user may be prompted to make choices in response to prompts by the system. Depending on the nature of the call, these responses may comprise, for example, instructions to buy or sell stock, to replenish inventory, or to buy or rebook an airline flight. User response module 1815 comprises a database to store these responses along with an identification of the call in which they were given. The identification of the call in which they were given is important to determining what should be done with these responses after the call is terminated. User responses may be passed back to intelligence server 16 after the call is complete. The responses may be processed during or after the call, by the system or by being passed to another application.

Statistics accumulator 1816 comprises a module that accumulates statistics regarding calls placed by call builder 1813. These statistics including, for example, the number of times a particular call has been attempted, the number of times a particular call has resulted in voice mail, the number of times a user responds to a call and other statistics, can be used to modify future call attempts to a particular user or the structure of a voice service provided to a particular user. For example, according to one embodiment, statistics accumulator 1816 accumulates the number of times a call has been unsuccessfully attempted by call builder 1813. This type of information is then used by call server 18 to determine whether or not the call should be attempted again, and whether or not a voice mail should be left.

Call server 18 also comprises certain hardware components 182. As shown in FIG. 1c, hardware components 182 comprise processor 1821 and computer telephone module 1822. According to one embodiment, processor 1821 comprises a Pentium II processor, available from Intel, Inc. Module 1822 provides voice synthesis functionality that is used in conjunction with Text to Speech engine 1814 to communicate the content of voice services to a user. Module 1822 preferably comprises voice boards available from Dialogic, Inc. Other processors and voice synthesizers meeting system requirements may be used.

The system and method of the present invention may form an integral part of an overall commercial transaction processing system.

According to one embodiment of the present invention, a system and method that enable closed-loop transaction processing are provided. The method begins with the deployment of an IVB by executing a service. As detailed above, this includes generating the content and combining this with personalization information to create an active voice page. Call server 18 places a call to the user. During the call, information is delivered to the user through a voice-enabled terminal device (e.g., a telephone or cellular phone).

During the IVB, a user may request a transaction, service, further information from the database or other request, e.g., based on options presented to the user. These will generically be referred to as transactions. The request may be, but is not necessarily, based on or related to information that was delivered to the user. According to one embodiment, the request comprises a user response to a set of options and/or input of information through a telephone keypad, voice input or other input mechanism. According to another embodiment, the request can be made by a user by speaking the request. Other types of requests are possible.

According to one embodiment, the user responses are written to a response collection, which along with information stored in the active voice page, can be used to cause a selected transaction to be executed. According to one embodiment, the active voice page comprises an XML-based document that includes embedded, generic requests, e.g., a request for a transaction, or a request for additional information (a database query). These embedded requests are linked with, for example option statements or prompts so that when a user enters information, the information is entered into the generic request and thus completes a specific transaction request. For example, in the example if a user exercises an option to buy a particular stock, that stock's ticker symbol is used to complete a generic “stock buy” that was embedded in the active voice page.

According to one embodiment, tokens are used to manage user inputs during the IVB. A token is a temporary variable that can hold different values during an IVB. When a user enters input, it is stored as a token. The token value is used to complete a transaction request as described above. According to one embodiment, the system maintains a running list of tokens, or a response collection, during an IVB.

In order to complete the requested transaction, the user responses (and other information from the active voice page) may need to be converted to a particular format. The format will depend, for example, on the nature and type of transaction requested and the system or application that will execute the transaction. For example, a request to purchase goods through a web-site may require the information to be in HTML/HTTP format. A request for additional information may require and SQL statement. A telephone-based transaction may require another format.

Therefore, the transaction request is formatted. According to one embodiment, the transaction is formatted to be made against a web-based transaction system. According to another embodiment, the transaction request is formatted to be made against a database. According to another embodiment, the transaction is formatted to be made against a telephone-based transaction system. According to another embodiment, the transaction is formatted to be made via e-mail or EDI. Other embodiments are possible.

In one embodiment, the formatted transaction request comprises an embedded transaction request. The system described in connection with FIGS. 1-3 provides interactive voice services using TML, a markup language based on XML. Using TML active voice pages are constructed that contain the structure and content for a interactive voice broadcast including, inter alia, presenting the user with options and prompting the user for information. Moreover in connection with OPTION and PROMPT elements, active voice pages also can include embedded statements such as transaction requests. Therefore, the formatting for the transaction request can be accomplished ahead of time based on the particular types of transactions the user may select.

For example, in connection with an exemplary stock purchase, an active voice page can include an embedded transaction request to sell stock in the format necessary for a particular preferred brokerage. The embedded statement would include predefined variables for the name of the stock, the number of shares, the type of order (market or limit, etc.), and other variables. When the user chooses to exercise the option to buy or sell stock, the predefined variables are replaced with information entered by the user in response to OPTION or PROMPT elements. Thus, a properly formatted transaction request is completed.

In the system of FIGS. 1-3, TML parsing, engine in call server 18 includes the functionality necessary to generate the properly formatted transaction request as described above. For example, in connection with the embodiment described above, the TML, parsing engine shown in FIG. 3c reads the active voice pages. When the TML parsing engine reads an OPTION element that includes and embedded transaction request, it stores the transaction request, and defines the necessary variables and variable locations. When the user exercises that OPTION, the user's input is received by the TML parsing, engine and placed at the memory locations to complete the transaction request This technique could be used, for example, to generate a formatted transaction request for web-site.

According to another embodiment, where the transaction request is made via a natural language, voice request, a formatted transaction request can be generated in a number of ways. According to one embodiment, speech recognition technology is used to translate the user's request into text and parse out the response information. The text is then used to complete an embedded transaction request as described above. According to another embodiment, speech recognition software is used to translate the request to text. The text is then converted to a formatted request based on a set of known preferences.

A connection is established with the transaction processing system. This can be accomplished during, or after the IVB. According to one embodiment, the transaction processing system comprises a remotely located telephone-based transaction site. For example, in the system shown in FIGS. 1-3, call server 18, through the TML parsing engine 1812, establishes a connection with a telephone-based transaction processing site.

According to another embodiment, the transaction processing system comprises a remotely based web-site. According to this embodiment, the formatted request includes a URL to locate the web-site and the system accesses the site through a web connection using the formatted request. Alternatively, the formatted request includes an e-mail address and the system uses any known email program to generate an e-mail request for the transaction.

After the connection is established, the transaction is processed by the transaction processing site and the user is notified of the status of the transaction. If the transaction is completed in real-time, the user may be immediately notified. If the transaction is executed after the IVB, the user may be called again by the system, sent an e-mail, or otherwise notified when the transaction has been completed.

According to one particular embodiment, the system comprises the interactive voice broadcasting system shown and described in FIGS. 1-3 and the transaction is accomplished in real-time. In this embodiment, confirmation of the transaction is returned to TML parsing engine 1812 shown in FIG. 3 and translated to speech in text-to-speech engine 1814 and presented to the user during the IVB. More specifically, and similar to the process described with respect to embedded formatted transaction requests, TML also enables embedding of a response statement. Thus, when the transaction is processed and confirmation of the transaction is returned to the system, an embedded confirmation statement is conveyed to the user through TML parsing engine 1812 after being converted to speech in text-to-speech engine 1814.

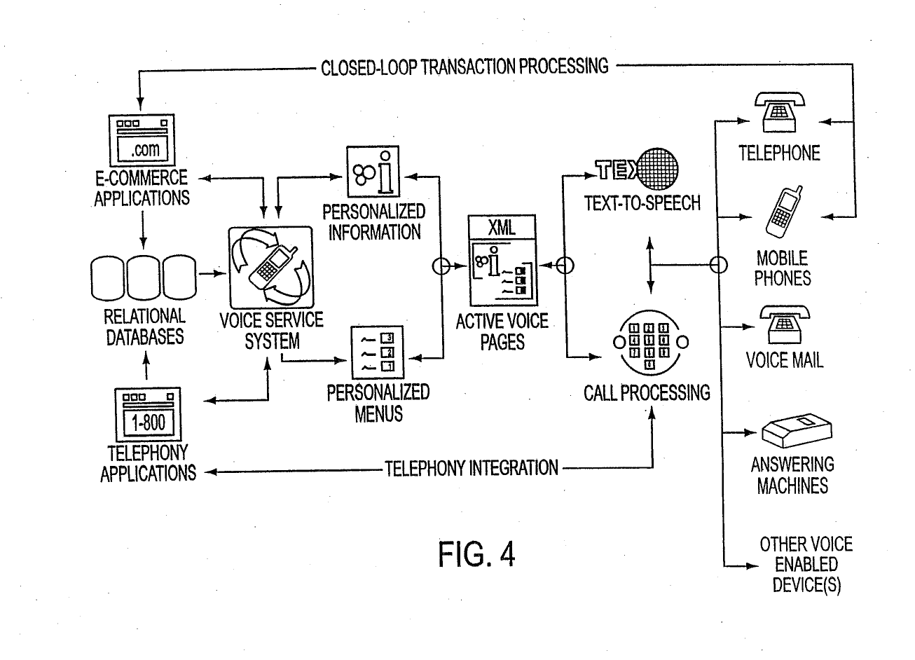

FIG. 4 schematically depicts one example of how the system and method of the present invention would fit into such a commercial transaction processing system. Working from left to right in FIG. 4, the system begins and ends with information stored in relational databases. One of the primary purposes of information is in making decisions. Thus, the information in the databases is most useful if provided to someone who desires it in a timely fashion.

A voice service system is provided to enable access to the information in the databases. The voice service system utilizes personalization information and personalized menus to construct AVPs pages that enable the information to be delivered to a user verbally. Moreover, the AVPs pages, not only enable information to be presented to the user. But, they also enable the user to provide information back to the voice service system for additional processing.

According to the embodiment shown in FIG. 4, once the AVPs are constructed by voice service system, they are processed and the content is delivered to a user verbally in an IVB. Thus, call processing and text-to-speech technology are used to establish a telephone connection with a user and convert the active voice pages to speech for presentation to the user. As shown in FIG. 4, the IVB may be delivered to a user in many devices, including a telephone, a mobile phone, voice mail, an answering machine or any other voice-enabled device.

During the IVB, depending on the content that is being delivered, control may be passed to an e-commerce application for the user to complete a transaction based on the information presented. For example, if the user has requested information about sales on a particular brand of merchandise, the user may be connected with a particular retailer in order to complete a transaction to buy a particular good or service. Information about this transaction is then added to the databases and thus may be advantageously accessed by other users.

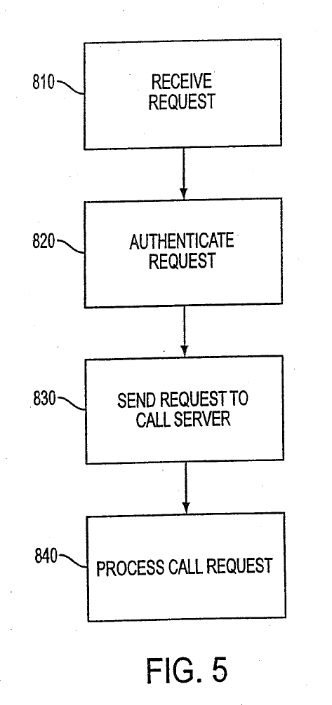

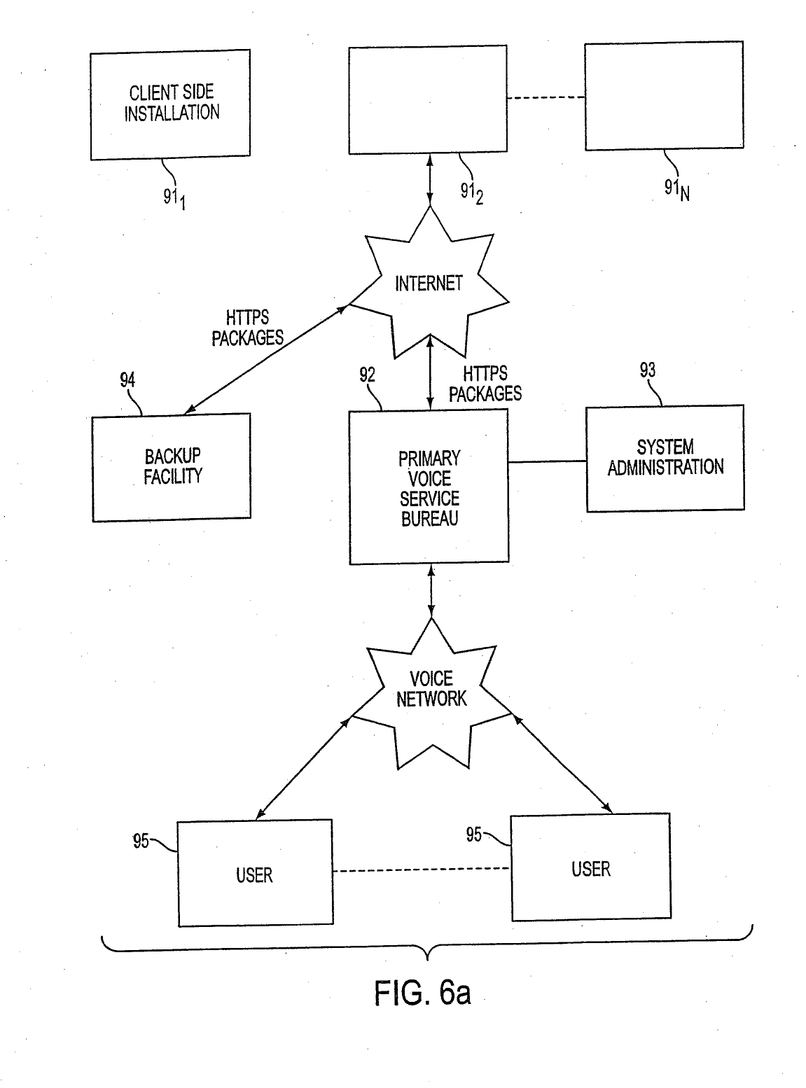

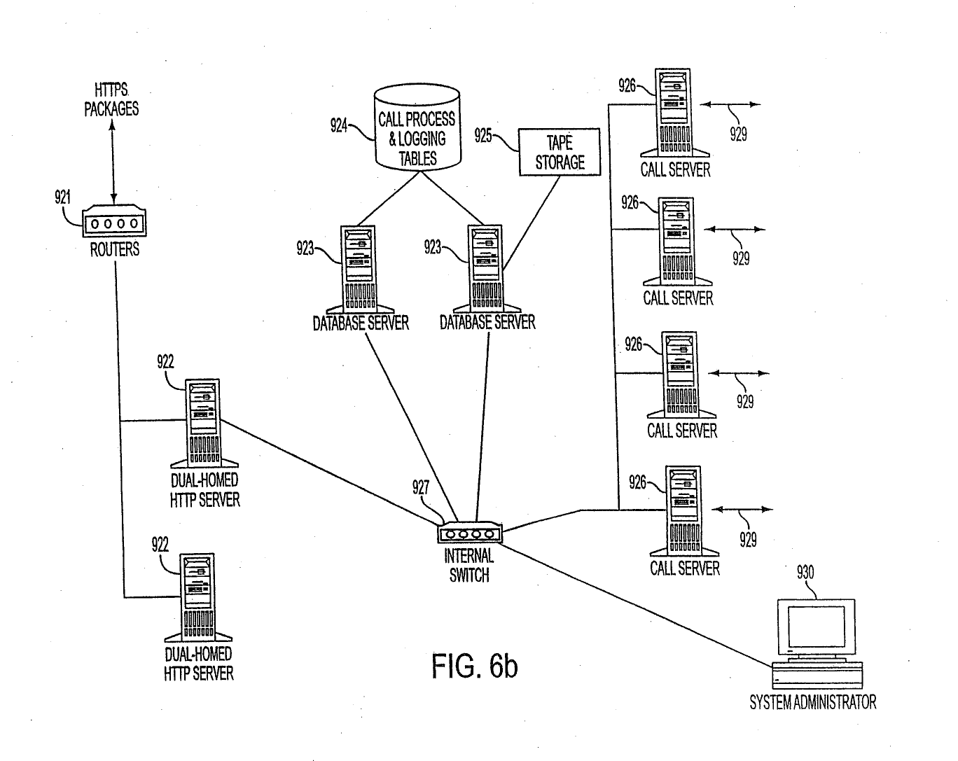

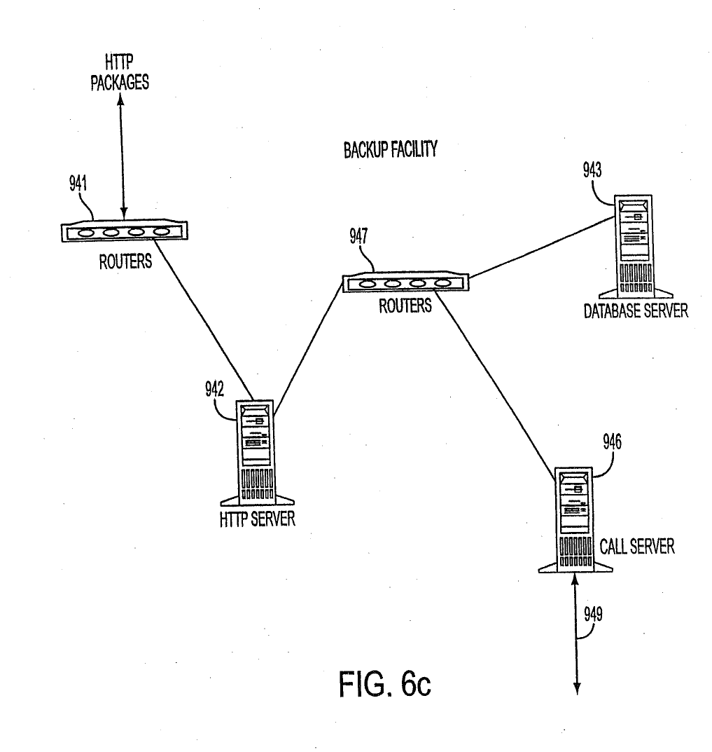

It may not be economical for some potential users of a voice broadcasting system to buy and/or maintain their own telephony hardware and software as embodied in call server 18. In such a case, a voice service bureau may be maintained at a remote location to service users voice service requests. A voice service bureau and a method of using a voice service bureau according to various embodiments of the present invention is described in conjunction with FIGS. 5-6.

In one embodiment, a voice service bureau may comprise one or more call servers and call databases that are centrally located and enable other voice service systems to generate a call request and pass the call request to the VSB to execute a call. In this way the other voice service systems do not need to invest in acquiring and maintaining call data bases, call servers, additional telephone lines and other equipment or software. Moreover, the VSB facilitates weeding out usage of illegal numbers and spamming by number checking implemented through its web server.

A voice service bureau and a method of using a voice service bureau according to one embodiment are described in conjunction with FIGS. 5-6. FIG. 5 depicts a method of utilizing a voice service bureau according to one embodiment of the present invention. The method begins in step 810 with a request to place one or more telephone calls received through a computer network.

According to one embodiment, the voice service bureau is maintained at a location distant from the voice service system. Therefore, in order for a voice service to be processed by the voice service bureau, in step 810 the voice service is sent to the voice services bureau, preferably over some secure line of communication. According to one embodiment, the request is sent to the voice service bureau through the Internet using secure HTTPS. HTTPS provides a secure exchange of data between clients and the voice service bureau using asymmetric encryption keys based on secure server certificates. In another embodiment, SSL HTTP protocol is used to send a call request to the voice service bureau. Both of these protocols help ensure that a secure channel of communication is maintained between the voice service system and the voice service bureau. Other security techniques may be used.

When a request for a call or telecast is received, by the VSB, the request is authenticated by the voice service bureau in step 820. According to one embodiment, the authenticity of the request is determined in at least two ways. First, it is determined whether or not the request was submitted from a server having a valid, active server certificate. More specifically, requests may be typically received via a stream of HTTPS data. Each such request originating from a server with a valid server certificate will include an embedded code (i.e., server certificate) that indicates the request is authentic. In addition to the use of server certificates, each request may also be authenticated using an identification number and password. Therefore, if the request submitted does not include a valid server certificate and does not identify a valid I.D./password combination, the request will not be processed. The step of authenticating also comprises performing any necessary decryption. According to one embodiment, any errors that are encountered in the process of decrypting or authenticating the call request are logged an error system and may be sent back to the administrator of the sending system. Other methods of authenticating the request are possible.

Each properly authenticated request is sent to a call server (step 830) and processed (step 840). According to one embodiment, the voice service bureau comprises a number of call servers. According to one embodiment, the calls are sent to a call database, and processed as set forth herein in conjunction with the explanation of call server 18.

One embodiment of a voice service bureau will now be explained in conjunction with FIGS. 6a-6c. FIG. 6a depicts a system comprising a plurality of client side installations 91, a primary voice bureau 92, a system administrator 93, a backup voice service bureau 94, and a plurality of users 95. Client side installations 91 communicate with voice service bureau 92 through a computer network. Voice service bureau 92 communicates with users 95 through a voice network. According to one embodiment, the computer network comprises the internet and client side installations 91 communicate with voice service bureau 92 using HTTPS as described above, and the voice network comprises a public telephone network.

According to one embodiment, client side installations 91 are substantially identical to the system shown in FIG. 4 except for the elimination of call server 18. In the system of FIG. 6a, the functionality of call server 18 is performed by VSB 92. As shown in this embodiment, VSB 92 can service multiple client side installations 91₁ to 91n. According to another embodiment, client-side installation functionality may be included within VSB 92. According to this embodiment VSB 92 constitutes a fully functional voice service that is accessible through email, telephone or other interfaces.

According to this embodiment, when voice services have been assembled by intelligence server 16, a request to have the voice services transmitted is sent via a secure network connection through the computer network shown to primary voice bureau 92 and backup voice service bureau 94 as described above. According to one embodiment, the request comprises a mark-up language string that contains the voice service structure and content and personal style properties and other information. As described above, voice bureau 92 authenticates the request, queues the voice services and sends telecasts to users 95 through the voice network.

A block diagram of one embodiment of primary voice bureau 92 is shown in FIG. 6b. According to this embodiment, primary voice bureau comprises routers 921, dual-homed servers 922, database servers 923, call database 924, backup storage 925, call servers 926, internal switch 927, and system administrator 928. Routers 921 receive call requests via a computer network and pass them along to one of the two dual-homed servers 922. Router 921 monitors activity on servers 922 and forwards call requests to one of the two depending on availability.

Dual-homed servers 922 comprise servers configured to receive and send HTTPS email. As part of their receiving function, dual-homed servers 922 are configured to perform the authentication processing described above. According to one embodiment, dual-homed servers 922 determine whether the incoming request originated from a server with an active server certificate and also determine if the request contains a valid I.D./password combination. Once dual-homed servers 922 have authenticated the incoming request, they forward the request to be queued in call database 924. As part of their sending function, dual-homed servers 922 are configured to format and send HTTPS email. As discussed above, during a telecast a user may request that further information be accessed from a database or that some transaction be performed. According to one embodiment, these user requests are forwarded back to the originating, system via HTTPS email by dual-homed servers 922. Dual-homed servers 922 are load balanced to facilitate optimal performance and handling of incoming call requests.

Database servers 923, call database 924, and backup storage 925 together comprise a call request queuing system. Primary voice bureau 92 is configured to handle a large number of call requests. It may not be possible to process call requests as they arrive. Therefore, call requests are queued in call database 924. According to one embodiment, call database 924 comprises a relational database that maintains a queue of all call requests that need to be processed as well as logs of calls that have been processed. According to another embodiment, primary VSB 92 may include a failover measure that enables another system server to become the call database if call database 924 should fail.

Database servers 923 are configured to control access to call database 924. According to one embodiment, database servers may be optimized to generate SQL statements to access entries in call database at high speed. Database servers 923 also control storage of call requests and call logs in call database 924.

Call servers 926 each are configured to format and send telecasts. According to one embodiment, each of call servers 926 is substantially identical to call server 18 shown in FIG. 3c. More specifically, each of call servers 926 receives requests for telecasts, parses the call content from the mark-language, establishes a connection with the user through phone lines 929, and receives user responses. According to one embodiment, call servers 926 comprise a clustered architecture that facilitates message recovery in the event of server failure.

Primary voice bureau 92 is controlled by system administrator 93 and internal switch 927. System administrator controls switch 927 and thus controls the flow of call requests to call database 924 from dual homed servers 922 and to call servers 926 from call database 924.

System administrator 93 is also configured to perform a number of other services for primary voice bureau 92. According to one embodiment, system administrator 93 also comprises a billing module, a statistics module, a service module and a security module. The billing modules tabulates the number of voice service requests that come from a particular user and considers the billing plan that the customer uses so that the user may be appropriately billed for the use of voice bureau 92. The statistics module determines and maintains statistics about the number of call requests that are processed by voice bureau 92 and statistics regarding call completion such as, e.g., success, failed due to busy signal and failed due to invalid number. These statistics may be used, for example, to evaluate hardware requirements and modify pricing schemes. The security module monitors activity on voice bureau 92 to determine whether or not any unauthorized user has accessed or attempted, to access the system. The service module provides an interface through which primary voice bureau 92 may be monitored, for example, to determine the status of call requests. Other service modules are possible. Moreover, although these services are described as distinct modules, their functionality could be combined and provided in a single module.

Backup voice service bureau 94 receives a redundant request for voice services. Backup voice service bureau 94 processes the requests only when primary voice service bureau is offline or busy. One embodiment of backup voice service bureau 94 is shown in FIG. 6c. Backup voice bureau 94 comprises routers 941, HTTP server 942, database server 943, call server 946 and routers 947. Each of these components performs a function identical to the corresponding element in primary voice bureau 92. Router 947 replaces switch 927. Router 947 controls the forwarding of call requests to database server 943 for queuing in an internal database, and the forwarding of call requests to call server 946 from database server 943.

The systems and methods discussed above are directed to outbound broadcasting of voice services. Nevertheless, in certain situations, for example when the out bound telecast is missed, it is desirable to for a voice service system to enable inbound calling. According to another embodiment, a method and system for providing integrated inbound and outbound voice services is disclosed.

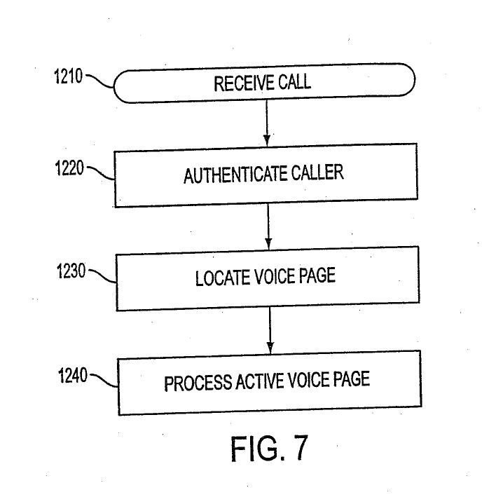

A method for providing inbound access to voice services according to one embodiment of the present invention is shown in FIG. 7. According to FIG. 7, the method begins with receipt of a call requesting voice services in step 1210. To help ensure system integrity and to prevent unauthorized access, a call request is authenticated in step 1220. According to one embodiment, each incoming caller is automatically prompted to enter a login identifier and a PIN. According to another embodiment, an automatic number identification system is used, in addition to a login identifier and PIN system, to determine whether or not the user is calling from an authorized device. According to another embodiment, speaker recognition technology is utilized to identify a caller. According to this embodiment, voice prints for each user of the voice service system are stored as identifiers. When an inbound call is connected, pattern matching techniques are used verify the user's speech against the previously stored voice prints. Other security measures are possible.

In step 1230, a voice page is located. As explained above, a telecast of a voice service is driven by an active voice page. Accordingly, a user calling in to access voice services locates the desired active voice page. According to one embodiment, the user is automatically placed into an active voice page of a voice service that the user missed. That is, the system chooses an active voice page that it was unable to deliver. According to this embodiment, when a call is undeliverable (e.g., when an answering machine picks up), the active voice page for that call is placed in memory in a “voice site” table or as an active voice page on a web site and addressed using the user's identification. When the user calls in to retrieve the voice service, after the user logs in, the table or web site will be searched for an active voice page that corresponds to their identification. If such a page exists, it is executed by the call server.

Other possibilities exist for accessing active voice pages through inbound calling. According to another embodiment, the system maintains a log of all voice services sent and provides an inbound user an option to select one of their previous voice services. According to another embodiment, an inbound caller is automatically placed into an active voice page that presents the user with an option to select one of that user's most frequently used services. According to still another embodiment, the user is allowed to search for past active voice pages by date or content. For example, the user may be prompted to enter a date on or near which the desired voice page was executed. According to another embodiment, the user may use the telephone keys to enter a search term and search the content of any previously executed active voice page that they are authorized to access or that is not secure.

Once an active voice page is located, the user navigates through the active voice page in step 1240. As described above, a user navigates through an active voice by exercising options, responding to prompts and otherwise entering input to the system. An inbound calling system would thus have access to the full functionality of the voice service system described in conjunction with FIGS. 1-6.

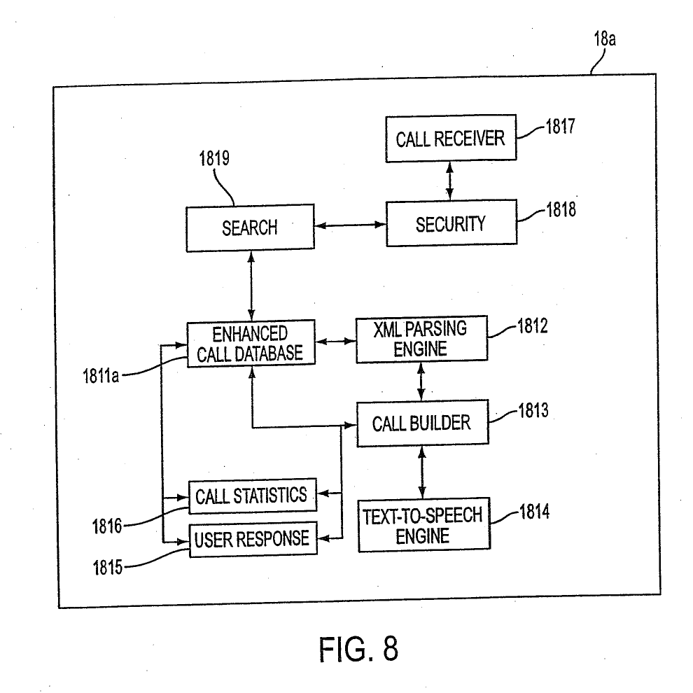

FIG. 8 depicts a block diagram of a call server 18a that enables integrated inbound and outbound calling. In addition to the modules depicted in call server 18 of FIG. 3, call server 18a comprises call receiver module 1817, security module 1818 and search module 1819. Moreover, in the system for permitting inbound and outbound calling, call database 1811 has been replaced with an enhanced call database 1811a.

In order to receive inbound calls, call server 18a comprises call receiver module 1817. Although, call server 18 discussed above contains hardware permitting reception of calls as well as transmission of calls, it is not set up to receive calls. Call receiver module 1817 enables call server 18a to receive calls and routes the incoming calls to security module 1818. According to one embodiment, call receiver module comprises a software component designed to configure call server 18a to receive calls. Other embodiments are possible.

Received calls are forwarded to security module 1818 for authentication. According to one embodiment discussed above, incoming calls are authenticated using login I.D.'s and passwords. According to another embodiment, automatic number identification software is used to identify and authenticate callers. According to another embodiment, speech recognition and pattern matching techniques are used to identify a caller.

Authenticated calls may search for an active voice page using search module 1819. According to one embodiment, search module 1819 comprises a search engine designed specifically to search active voice pages. According to one embodiment discussed above, active voice pages utilize an XML-based language and search module 1819 comprises an XML-based search engine. According to another embodiment, search module 1819 comprises a SQL engine designed to make queries against a relational or other type of database.

The active voice pages that are being search are stored in enhanced call database 1811a. In addition to its facilities to queue and log calls, enhanced call database 1811 includes facilities to catalog active voice pages. According to one embodiment, enhanced call database comprises a relational or other type of database. According to this embodiment, enhanced call database is used to store and categorize active voice pages and corresponding parameters, such as expiration dates for active voice pages. Other storage facilities are possible.

Various features and functions of the present invention extend the capabilities of previously known information delivery systems. One such system is Micro Strategy's Broadcaster version 5.6. The features and functions of the present invention are usable in conjunction with Broadcaster and other information delivery systems or alone. Other products may be used with the various features and functions of the invention including, but not limited to, MicroStrategy's known product suite.

Other embodiments of the invention will be apparent to those skilled in the art from consideration of the specification and practice of the invention disclosed herein. The specification and examples should be considered exemplary only. The scope of the invention is only limited by the claims appended hereto.

What is claimed is:

1. A method for providing real-time transmissions of entertainment information to a user subscribed to an entertainment service, wherein the user has a personal profile, the method comprising:
determining information based on the entertainment service and the personal profile;
generating content related to entertainment from the determined information;
establishing communication with the user using personal information; and
communicating the content related to entertainment to the user through the entertainment service.

2. The method according to claim 1, wherein the step of determining information further comprises determining whether an entertainment opportunity matches the personal profile.

3. The method of claim 2 further comprising the step of enabling the user to provide input in response to information provided about the entertainment opportunity.

4. The method of claim 3 wherein the input is associated with the information provided about the entertainment opportunity in a user history.

5. The method of claim 2 wherein the communication with the user is attempted on a first terminal device and selectively attempted on a second terminal device.

6. The method of claim 5 further comprising the step of selectively modifying the service based on the user input.

7. The method of claim 6 wherein the service modification comprises subscribing, the user to a new service and unsubscribing the user from the entertainment service.

8. The method of claim 2 wherein a user calendar is used in determining whether an entertainment opportunity is transmitted to the user.

9. The method of claim 2 further comprising the step of selectively modifying a user history based on the user input.

10. The method of claim 9 wherein the user history comprises a record of entertainment opportunities offered to the user and a record of user input.

11. The method of claim 2 wherein the system selectively filters information about entertainment opportunities that have already been offered to the user.

12. The method of claim 11 wherein the system does not transmit information about entertainment opportunity if information relating to the entertainment opportunity has already been offered to the user unless the new information more closely matches the personal profile settings.

13. The method of claim 2 wherein the system modifies the entertainment service based upon the user input of a plurality of users.

14. A system for providing real-time transmissions of entertainment information to a user having personal information in a personal profile and a user history including information regarding at least one entertainment opportunity, the system comprising:
means for receiving information from a user personal information and an entertainment opportunity data source;
means for determining information based on the personal information and the at least one entertainment opportunity;
means for generating content from determined information;
means for establishing communication with the user using personal information;
means for communicating the content to the user.

15. The system according to claim 14, wherein the means for determining information further comprise means for determining that the at least one entertainment opportunity identified in the user history has been altered;
further comprising means for determining options to modify the user input associated with the at least one altered entertainment opportunity; and
wherein generating content includes generating content from the at least one altered entertainment opportunity and the options.

16. The system according to claim 15, further comprising means for receiving, a transmission from the user in response to the content, wherein the transmission comprises instructions to modify the user input associated with the entertainment opportunity.

17. The system according to claim 15, further comprising the step of converting the content to speech output; and wherein the step of establishing communication comprises establishing voice communication.

18. The system according to claim 17, wherein the means for communicating the content comprises means for communicating the speech output.

19. The system according to claim 18, wherein establishing voice communication includes establishing telephone communication.

20. The system according to claim 15, wherein the entertainment opportunity matching is partially determined by a user's calendar.

21. The system according to claim 15, wherein the means for transmitting content to the user further comprises means for prompting the user to select at least one the determined options to modify the altered entertainment opportunity.

22. The system according to claim 15, wherein the generated content delivered to the user comprises information that the entertainment service has been initiated due to a change in an entertainment opportunity, and identifies what the change is.

23. The system according to claim 22, wherein the generated content further comprises information relating to the determined options to modify the at least one other entertainment opportunity.

24. The system according to claim 15, wherein the means for determining options includes means for consulting a user calendar.

25. The system according to claim 15, wherein the means for determining options includes means for consulting the calendars for at least two users.

26. The system of claim 25, wherein input by a first user is transmitted to a second user.

27. The system of claim 14, wherein the user may add parameters to a personal profile through the use of mark-up tags.

28. The system of claim 14, wherein information associated with an entertainment opportunity that has already been offered to the user is selectively filtered.
